(19) United States
(12) Patent Application Publication
(10) Pub. No.: US 2024/0151557 A1
(43) Pub. Date: May 9, 2024

(54) Touch Sensors for Interactive Objects with Multi-Dimensional Sensing

(71) Applicant: Google LLC, Mountain View, CA (US)

(72) Inventors: Tony Wu, Mountain View, CA (US); Kishore Sundara-Rajan, Redwood City, CA (US)

(21) Appl. No.: 18/548,828

(22) PCT Filed: Mar. 1, 2021
(86) PCT No.: PCT/US2021/020231

§ 371 Date: Sep. 1, 2023

(51) Int. Cl. G01D 5/24; G06F 3/044

(52) U.S. Cl. CPC G01D 5/24; G06F 3/044; G06F 2203/04102

(57) ABSTRACT

A sensor system (200) that includes a flexible substrate (502), a plurality of first sensing lines (504-X), and a plurality of second sensing lines (510-X) is disclosed. The flexible substrate has a first surface (506) and an opposite, second surface (508). The plurality of first sensing lines are substantially parallel and are spaced apart in the lateral direction, wherein each of the plurality of first sensing lines is coupled to the first surface of the flexible substrate. At least a portion of each of the plurality of second sensing lines is exposed on the first surface and at least a second portion of each of the plurality of second sensing lines is exposed on the second surface. The sensor system further detects, based on signals from the plurality of first sensing lines and the plurality of second sensing lines, that a user has made a swipe gesture along the first surface in the longitudinal direction.

### FIELD

The present disclosure relates generally to touch sensors for interactive objects.

### BACKGROUND

An interactive object can include conductive sensing elements such as conductive lines incorporated into the interactive object to form a sensor such as a capacitive touch sensor that is configured to detect touch input. The interactive object can process the touch input to generate touch data that is usable to initiate functionality locally at the interactive object or at various remote devices that are wirelessly coupled to the interactive object. Interactive objects may include conductive sensing elements for other purposes, such as for strain sensors using conductive threads and for visual interfaces using line optics.

An interactive object may be formed to include a sensing region of conductive thread woven into an interactive textile, for example. Each conductive thread can include a conductive wire (e.g., a copper wire) that is twisted, braided, or wrapped with one or more flexible threads (e.g., polyester or cotton threads). It may be difficult, however, for traditional sensor designs with such conductive lines to be implemented within objects.

### SUMMARY

Aspects and advantages of embodiments of the present disclosure will be set forth in part in the following description, or may be learned from the description, or may be learned through practice of the embodiments.

One example aspect of the present disclosure is directed to a sensor system that includes a plurality of first sensing lines, a plurality of second sensing lines, a flexible substrate, and one or more control circuits. The flexible substrate has a first surface and an opposite, second surface and defines a longitudinal direction and a lateral direction perpendicular to the longitudinal direction. The plurality of first sensing lines extend in the longitudinal direction of the flexible substrate and being substantially parallel and spaced apart in the lateral direction, wherein each of the plurality of first sensing lines is coupled to the first surface of the flexible substrate within a sensing region having a length in the longitudinal direction. The plurality of second sensing lines extend in the longitudinal direction of the flexible substrate and substantially parallel with the plurality of first sensing lines, wherein at least a first portion of each of the plurality of second sensing lines is exposed on the first surface of the flexible substrate within the sensing region and at least a second portion of each of the plurality of second sensing lines is exposed on the second surface of the flexible substrate within the sensing region. The one or more control circuits are configured to detect, based on signals from at least two of the plurality of first sensing lines and at least two of the plurality of second sensing lines, that a user has made a swipe gesture along the first surface in the longitudinal direction.

Yet another example aspect of the present disclosure is directed to a computer-implemented method of managing input at an interactive object. The method includes detecting, from at least two of a plurality of first sensing lines and at least two of a plurality of second sensing lines, signals describing a user touch input directed to a sensing region of a flexible substrate. The flexible substrate has a first surface and an opposite, second surface, and defines a longitudinal direction and a lateral direction. The plurality of first sensing lines extending in the longitudinal direction and being substantially parallel and spaced apart in the lateral direction. Each of the plurality of first sensing lines is coupled to the first surface of the flexible substrate within a sensing region having a length in the longitudinal direction. The plurality of second sensing lines extend in the longitudinal direction of the flexible substrate and are substantially parallel with the plurality of first sensing lines. At least a portion of each of the plurality of second sensing lines is exposed on the first surface of the flexible substrate within the sensing region and at least a second portion of each of the plurality of second sensing lines is exposed on the second surface of the flexible substrate within the sensing region. The method includes determining, based on the signals, that a user has made a swipe gesture along the first surface in the longitudinal direction.

Another example aspect of the present disclosure is directed to an interactive object wearable by a user and including a touch sensor and one or more control circuits. The touch sensor comprises a plurality of conductive sensing lines integrated with a flexible substrate, the plurality of conductive sensing lines comprising a first conductive sensing line coupled to a first surface of the flexible substrate at a first sensing subregion and a second sensing subregion of the flexible substrate and a second conductive sensing line coupled to the first surface of the flexible substrate at the first sensing subregion and a second surface of the flexible substrate at the second sensing subregion. The one or more control circuits are configured to obtain touch data associated with a touch input to the touch sensor, the touch data indicative of a respective response to the touch input by the plurality of conductive sensing lines. The one or more control circuits are configured to determine whether the touch input is associated with the first sensing subregion or the second sensing subregion of the flexible substrate based at least in part on the respective response to the touch input by the plurality of conductive sensing lines.

Other example aspects of the present disclosure are directed to systems, apparatus, computer program products (such as tangible, non-transitory computer-readable media but also such as software which is downloadable over a communications network without necessarily being stored in non-transitory form), user interfaces, memory devices, and electronic devices for implementing and utilizing touch sensors such as capacitive touch sensors.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates an example computing environment including an interactive object having a touch sensor in accordance with example embodiments of the present disclosure;

FIG. 2 is a block diagram of an example computing environment that includes an interactive object having a touch sensor in accordance with example embodiments of the present disclosure;

FIG. 3 illustrates an example of a sensor system, such as can be integrated with an interactive object in accordance with example embodiments of the present disclosure;

FIG. 4 is a perspective view of an example of an interactive object including a capacitive touch sensor in accordance with example embodiments of the present disclosure;

FIG. 5A is a diagram representing a touch sensor with conductive sensing lines that can be coupled to either a first or second surface of a flexible substrate in accordance with example embodiments of the present disclosure;

FIG. 5B is a top view depicting a touch sensor including conductive sensing lines coupled to either a first or second surface of a flexible substrate in accordance with example embodiments of the present disclosure;

FIGS. 6A-6E depict example signals produced by the sensing lines as a touch input moves from sensing subregion A to sensing subregion E by passing through the other sensing subregions in accordance with example embodiments of the present disclosure;

FIG. 7 is a graphical diagram illustrating a set of sensing lines coupled to a first surface of a flexible substrate in different patterns along its longitudinal length in accordance with example embodiments of the present disclosure;

FIG. 8 is a graphical diagram illustrating a set of sensing lines coupled to a first surface of a flexible substrate in different patterns along its length in accordance with example embodiments of the present disclosure;

FIG. 9 depicts an example of a touch sensor including individual subsets of sensing lines coupled to surfaces of a flexible substrate in accordance with example embodiments of the present disclosure;

FIG. 10 is a block diagram depicting an example computing environment 1000, illustrating the detection of gestures based on an identified input location of a touch sensor in accordance with example embodiments of the present disclosure;

FIG. 11 is a flowchart depicting an example process of generating touch data in response to touch input detected by a touch sensor in accordance with example embodiments of the present disclosure;

FIG. 12 is a flowchart depicting an example process of determining a touch input location in accordance with example embodiments of the present disclosure;

FIG. 13 is a diagram depicting a context switching system for touch inputs in accordance with example embodiments of the present disclosure; and

FIG. 14 depicts a block diagram of an example computing system that can be used to implement example embodiments in accordance with the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to a sensor system including a touch sensor having a set of conductive sensing lines that can be integrated with at least one flexible substrate to form an interactive object that is capable of distinguishing inputs in multiple dimensions at the substrate surface. A plurality of sensing lines can be arranged in parallel along the flexible substrate. In example embodiments, the sensor system can detect that a user has made a swipe gesture along a surface of the touch sensor in a longitudinal direction parallel to the sensing lines. The sensor system can identify the location of a touch input in both a lateral direction along a lateral axis as well as in a longitudinal direction along a longitudinal axis. The flexible substrate can include at least a first surface and an opposite, second surface. In one example, the touch sensor can determine a lateral sensor response based on identifying one or more signals which indicate that one or more sensing lines were proximate to the touch input. It is noted that a touch may include physical contact with the touch sensor or simply placing an object proximate to the touch sensor sufficient to cause a detectable response. The touch sensor can determine a longitudinal sensor response based on identifying a longitudinal position along one or more of the sensing lines at which the touch is received. By way of example, the touch sensor can include at least one conductive sensing line that is coupled to the first surface of the flexible substrate at one sensing subregion of the flexible substrate and that is coupled to the second surface of the flexible substrate at a different sensing subregion of the flexible substrate. The capacitive response of the conductive sensing line to a touch at the first sensing subregion will be different from the capacitive response of the conductive sensing line to a touch at the second sensing subregion. As such, the sensor system can identify both a longitudinal component and a lateral component of touch inputs using a plurality of conductive sensing lines arranged in parallel.

Consider a specific example of a sensor system including a first conductive sensing line that is coupled to the first surface of the flexible substrate at a first sensing subregion and a second sensing subregion of the flexible substrate. A second conductive sensing line can be coupled to the first surface of the flexible substrate at the first sensing subregion of the flexible substrate and can be coupled to the second surface of the flexible substrate at the second sensing subregion of the flexible substrate. The first conductive sensing line and the second conductive sensing line can be parallel and adjacent in a lateral direction, and both elongated in a longitudinal direction such that they do not cross. When a touch input is sensed with respect to the second conductive sensing line, the sensor system can determine whether the touch input is associated with the first sensing subregion of the flexible substrate or the second sensing subregion of the flexible substrate based on the capacitive response of the second conductive sensing line to the touch input.

By way of example, the touch sensor can be integrated with an object (such as a jacket) to enable the user to interact with a computing device in communication with the touch sensor (e.g., a smartphone) by touching a portion of the interactive object (e.g., the sleeve of the jacket). The touch sensor can be fabricated such that one or more of the conductive sensing lines are alternatively coupled to the first surface or the opposite second surface of the touch sensor at different sensing subregions. For instance, a particular conductive sensing line may be coupled to a first surface (e.g., an upper or outer surface) of the flexible substrate at a first sensing subregion of the sensor and coupled to a second surface (e.g., a lower or inner surface) of the flexible substrate at a second sensing subregion of the sensor. When a user performs a gesture relative to the object (e.g., a swipe up or down the jacket sleeve), the conductive sensing lines can generate a capacitive response detectable by sensing circuitry of the touch sensor. One or more control circuits can determine, based on the capacitive response associated with the non-crossing conductive sensing lines, at which sensing subregion of the sensor the touch input was received. In this manner, example embodiments of the disclosed technology can enable a plurality of parallel conductive sensing lines to provide multi-dimensional sensing.

A touch sensor in accordance with example embodiments can include an array of conductive sensing elements positioned in a single dimension that enable touch inputs to be distinguished in two dimensions. In this manner, embodiments of the disclosed technology provide an improved capability to distinguish touch inputs by using parallel sensing lines to provide touch data that includes both lateral and longitudinal positional information. For instance, by distinguishing between individual sensing lines that are touched, a lateral sensor response or component can be determined. Additionally, by distinguishing where along a particular sensing line in a longitudinal direction a touch is received, the sensor system can distinguish touches at different sensing subregions of a touch sensor that has a plurality of non-crossing conductive sensing lines. Detecting touch inputs at different sensing subregions of a touch sensor enables the touch sensor to sense a greater number of distinct gestures and thus provide greater control to a user, thereby enabling tighter integration of multiple gesture capabilities using the touch sensor with interactive objects such as wearable devices.

More particularly, a sensor system in accordance with example embodiments can include a touch sensor and one or more control circuits that are configured to selectively detect input gestures at the touch sensor based on a surface at which the touch inputs are received. The one or more control circuits can include sensing circuitry configured to detect touch inputs to the touch sensor using the one or more conductive sensing lines. The sensing circuitry can generate sensor data based on the touch inputs. The one or more control circuits can additionally or alternatively include one or more processors local to an interactive object and/or one or more processors remote from the interactive object, such as at one or more remote computing devices.

The sensing elements can include a plurality of non-crossing conductive sensing lines. The non-crossing conductive sensing lines can be elongated in a longitudinal direction and have a spacing therebetween in a lateral direction substantially orthogonal to the longitudinal direction. The conductive sensing lines can be integrated with a flexible substrate having a first surface and an opposite second surface. The region of the flexible substrate in which the conductive sensing lines are integrated may be referred to as the sensing region.

Typically, non-crossing conductive sensing lines that extend in a single direction may be limited in the information they can provide to a touch sensor. For example, the touch sensor may be able to determine which non-crossing conductive sensing line responds to a touch input but may be unable to determine at which point along the line longitudinally the touch input was received. If no longitudinal position can be determined, the variety of touch inputs and gestures the touch sensor can recognize can be limited.

The present disclosure enables the sensor system to identify a longitudinal position for a particular touch input by providing a set of conductive sensing lines that are individually coupled to either the first surface of the flexible substrate or the second surface of the flexible substrate at different sensing subregions of the flexible substrate. Because the conductive sensing lines respond differently to touch inputs depending on whether they are coupled to the first surface of the flexible substrate or the second surface of the flexible substrate, the touch sensor can, based on the different responses, determine at which sensing subregion of the flexible substrate the touch input was received. Determining a longitudinal position for a touch input (in addition to the lateral position) allows the variety and number of touch inputs that the touch sensor can recognize to increase. Increasing the number and variety of possible touch inputs can result in an increase of usability for the users.

The plurality of non-crossing conductive sensing lines can be any type of conductive line that is used for sensing touch inputs in accordance with example embodiments of the present disclosure. By way of example, a conductive line can include a conductive thread, conductive fiber, fiber optic filaments, flexible metal lines, etc. A conductive thread of an interactive textile may include a conductive core that includes at least one conductive wire and a cover layer constructed from flexible threads that cover the conductive core. The conductive core may be formed by twisting one or more flexible threads (e.g., silk threads, polyester threads, or cotton threads) with the conductive wire, or by wrapping flexible threads around the conductive wire. In some implementations, the conductive core may be formed by braiding the conductive wire with flexible threads (e.g., silk). The cover layer may be formed by wrapping or braiding flexible threads around the conductive core. In some implementations, the conductive thread is implemented with a “double-braided” structure in which the conductive core is formed by braiding flexible threads with a conductive wire, and then braiding flexible threads around the braided conductive core. At least a portion of each conductive thread can be connected to a flexible substrate, such as by weaving, embroidering, gluing, or otherwise attaching the conductive threads to the flexible substrate. In some examples, the conductive threads can be woven with a plurality of non-conductive threads to form the flexible substrate. Other types of conductive lines may be used in accordance with embodiments of the disclosed technology. Although many examples are provided with respect to conductive threads, it will be appreciated that any type of conductive line can be used with the touch sensor according to example embodiments.

In some examples, the flexible substrate can include a first surface and a second surface, with a first sensing subregion and a second sensing subregion disposed longitudinally at the first surface. In some examples, the first surface and the second surface are on opposite sides of the flexible substrate in a direction orthogonal to the first surface and the second surface of the flexible substrate. A first non-crossing conductive sensing line can be coupled to a first surface of the flexible substrate at both the first sensing subregion and at the second sensing subregion of the flexible substrate. A second non-crossing conductive sensing line can be coupled to the first surface of the flexible substrate at the first sensing subregion and coupled to the second surface of the flexible substrate at the second sensing subregion. For example, the second non-crossing conductive sensing line can be coupled to the first surface at the first portion of the flexible substrate. At the second portion of the flexible substrate, the second conductive sensing line can be fabricated such that it tunnels through the flexible substrate and is coupled to the lower surface of the flexible substrate.

By integrating one or more of the conductive sensing lines at different surfaces of the flexible substrate at different sensing subregions of the flexible substrate, the sensing system can provide touch data that is indicative of touches in a longitudinal direction that is parallel to the length of the sensing lines. In this manner, the number of identifiable inputs can be increased by differentiating inputs according to a longitudinal position along the flexible substrate at which a touch input was received. For example, the sensor system can store data representing touch data that would be expected for each portion of the flexible substrate. This stored data can be used as a reference such that when touch data is received, the sensor system can determine which sensing subregion of the flexible substrate received the touch input.

In some examples, a first set of non-crossing conductive sensing lines is coupled exclusively to the first surface of the flexible substrate. Individual ones of a second set of non-crossing conductive sensing lines can be coupled to either the first surface of the flexible substrate or the second surface of the flexible substrate at different sensing subregions of the flexible substrate.

The one or more control circuits can obtain touch data that is generated in response to a touch input to the touch sensor. The touch data can be based at least in part on a response (e.g., resistance or capacitance) associated with a first conductive sensing line of a first subset of conductive sensing lines and a response associated with a second conductive sensing line of a second subset of sensing lines. The control circuit(s) can determine whether the touch input is associated with the first sensing subregion of the flexible substrate or a second sensing subregion of the flexible substrate based at least in part on the response associated with the first conductive sensing line and the response associated with the second conductive sensing line.

In accordance with some implementations, the one or more control circuits can analyze a respective response such as a resistance or capacitance of each sensing element of the touch sensor to determine whether a touch input is associated with the first sensing subregion of the flexible substrate or a second sensing subregion of the flexible substrate. For example, the control circuits can compare at least one capacitance of the first subset of sensing lines with at least one capacitance of the second subset of conductive sensing lines.

In some examples, the one or more control circuits can determine whether at least one signal difference associated with the particular conductive sensing line in the second subset of sensing lines is within a threshold value of at least one signal difference associated with the first subset of conductive sensing lines. For instance, a control circuit can determine, for one or more conductive sensing lines in the first set of conductive sensing lines, a signal difference between the capacitance of a particular conductive sensing line and the capacitance of an adjacent conductive sensing line in the second set of conductive sensing lines. In some examples, the one or more control signals can determine an average difference for a plurality of conductive sensing lines in the first set of conductive sensing lines.

In some examples, the first set of conductive sensing lines and the second set of conductive sensing lines can be arranged such that each sensing subregion of the flexible substrate has a different arrangement of conductive sensing lines in the second set of conductive sensing lines that are coupled to the first surface of the flexible substrate. Each arrangement can result in a unique pattern of responses from the conductive sensing lines that the one or more control circuits can use to determine which sensing subregion of the flexible substrate received the touch input. A simple example can include having a different conductive sensing line in the second set of conductive sensing lines coupled to the first surface of the flexible substrate in each sensing subregion of the flexible substrate.

In some examples, more complicated patterns can be used so that a greater number of subregions of the flexible substrate can be differentiated. For example, the sensor system can include five conductive sensing lines in the second set of conductive sensing lines that can couple to either the first surface of the flexible substrate or the second surface of the flexible substrate. When receiving data, the one or more control circuits can convert the responses of each of those conductive sensing lines into a binary value (1 or 0) depending on whether the conductive sensing line is coupled to the first surface of the flexible substrate (a binary 1) or the second service of the flexible substrate (a binary 0), as determined by the relative capacitive responses.

In this example, each touch input would result in a five-digit binary value based on the responses of the five conductive sensing lines. The five-digit binary value can be used to identify the particular sensing subregion of the flexible substrate from which the touch input originated. In some examples, the five-digit binary can be used as a key to a database or lookup table that associates five-digit binary keys with sensing subregions of the flexible substrate.

In addition to determining the longitudinal location of the touch input, the one or more control circuits can also determine the lateral position of the touch input. For example, when a touch input is received, the sensor system can determine a difference value for each of the conductive sensing lines based on the signal generated in response to the touch input. If little or no difference is determined for a particular conductive sensing line, the one or more control circuits can determine that the touch input was not received at the area near the particular conductive sensing line. The conductive sensing lines can be arranged such that each particular conductive sensing line is associated with a particular lateral position. The one or more control circuits can determine based on the response generated by each conductive sensing line where the touch input occurred in the lateral dimension (e.g., determining lateral component associated with the touch input).

Using the longitudinal section associated with the touch input and the lateral position associated with the touch input, the one or more control circuits can determine a specific location for the touch input on the flexible substrate. For example, the determined location could be represented as an (x, y) coordinate with the x-axis representing the lateral dimension of the flexible substrate and the y-axis representing the longitudinal dimension of the flexible substrate.

Once a location has been determined for the touch input, the one or more control circuits can identify a gesture associated with the touch input. Gestures can include, but are not limited to, taps, double-taps, presses, swipes, flicks, pinches, touch and hold, touch and drag, and so on. These gestures can be detected in multiple dimensions and include both lateral and longitudinal components.

For example, the sensor system can determine one or more positions associated with the touch input over a series of time steps. For example, at the first time step, the sensor system can determine that the touch input is associated with a first sensing subregion of the flexible substrate. In a second time step, the sensor system can determine that the touch input is associated with the second sensing subregion of the flexible substrate adjacent to the first sensing subregion of the flexible substrate. Based on these two positions at two subsequent time steps, the sensor system can determine that the touch input is associated with the swipe gesture moving from the first sensing subregion of the flexible substrate to the second sensing subregion of the flexible substrate.

In some examples, one or more locations associated with the touch input can correspond to one or more of the predefined parameter(s) for at least one gesture. By way of example, a correspondence between the movement of locations associated with touch data and gestures can be identified using matching criteria. For example, the similarity between the touch input and the respective gesture can be determined based on a number of corresponding features and parameters. In some examples, a correspondence between the touch data and a respective gesture can be detected based on a respective gesture associated with the largest number of touch input locations, as well as other features and parameters.

The one or more touch input locations can be used to identify matching patterns of touch location movement that are stored in a reference database and can be used to match specific detected touch inputs with a respective gesture in some example embodiments. The sensor system can compare the touch input location data with the one or more predefined patterns or parameters to determine whether the particular input gesture has been performed. Additional features of the touch data such as capacitance levels, resistance levels, line activation orders, a number of elements having a capacitance change, etc. can be compared to the pre-defined parameters in some examples.

Once a specific gesture has been determined, the computing system associated with an interactive object or computing device in communication with the interactive object can initiate one or more actions based on a detected gesture. For example, a detected gesture can be associated with a navigation command (e.g., scrolling up/down/side, flipping a page, etc.) in one or more user interfaces coupled to the interactive object (e.g., via the capacitive touch sensor, the controller, or both) and/or any of the one or more remote computing devices. In addition, or alternatively, the respective gesture can initiate one or more predefined actions utilizing one or more computing devices, such as, for example, dialing a number, sending a text message, playing a sound recording etc. In another example, the respective gestures can cause the interactive object (or associated computing device) to change the user context in which it is currently operating.

The following provides an end-to-end example of the technology described herein. A sensor system can be integrated with a wearable device. In some examples, the sensor system is a capacitive touch sensor. In some examples, a sensor system can include a flexible substrate having a first surface and an opposite, second surface, the flexible substrate defining a longitudinal direction and a lateral direction perpendicular to the longitudinal direction. The flexible substrate can include a first sensing sub-region and a second sensing sub-region.

The sensor system can include a plurality of first sensing lines extending in the longitudinal direction of the flexible substrate and being substantially parallel and spaced apart in the lateral direction, wherein each of the plurality of first sensing lines is coupled to the first surface of the flexible substrate within a sensing region having a length in the longitudinal direction.

The sensor system can also include a plurality of second sensing lines extending in the longitudinal direction of the flexible substrate and substantially parallel with the plurality of first sensing lines, wherein at least a portion of each of the plurality of second sensing lines is exposed on the first surface of the flexible substrate within the sensing region and at least a second portion of each of the plurality of second sensing lines is exposed on the second surface of the flexible substrate within the sensing region. In some examples, the plurality of first sensing lines are approximately equally spaced apart in the lateral direction. In some examples, each of the plurality of second sensing lines can be arranged between a respective pair of first sensing lines such that the first sensing lines alternate with the second sensing lines in the lateral direction.

In some examples, the sensor system can include a respective second sensing line that is coupled to the first surface of the flexible substrate at the first sensing sub-region of the flexible substrate and coupled to the second surface of the flexible substrate at the second sensing sub-region of the flexible substrate.

In some examples, the sensor system can include, as part of the flexible substrate, a third sensing sub-region. A respective first sensing line can be coupled to the first surface of the flexible substrate at the first sensing sub-region, the second sensing sub-region, and the third sensing sub-region of the flexible substrate. A respective second sensing line can be coupled to the second surface of the flexible substrate at the first sensing sub-region and the third sensing sub-region of the flexible substrate and is coupled to the first surface at the second sensing sub-region of the flexible substrate. Additional sensing subregions can be provided in example embodiments.

In some examples, a respective first sensing line can be coupled to the first surface at the first sensing subregion and the second sensing subregion and coupled to the second surface at the third sensing subregion of the flexible substrate. A respective second sensing line can be coupled to the first surface of the flexible substrate at the first sensing subregion and the third sensing subregion and coupled to the second surface of the flexible substrate at the second sensing subregion. In some examples, the plurality of first sensing lines can be coupled to the first surface of the flexible substrate along the length of the sensing region.

In some examples, a sensing region of the flexible substrate is divided in the longitudinal direction into a plurality of sensing subregions, the plurality of sensing subregions being free of overlap with each other in the longitudinal direction, and wherein only a single respective sensing portion of the plurality of second sensing lines is exposed within each respective sensing subregion. Each sensing portion of the plurality of second sensing lines can be free of overlap in the longitudinal direction with the sensing portions of neighboring second sensing lines of the plurality of second sensing lines.

The sensor system can include one or more control circuits. The control circuits can be configured to enable the sensor system to detect from at least two of the plurality of first sensing lines and at least two of the plurality of second sensing lines, signals describing a user touch input directed to the sensing region of the flexible substrate. The sensor system can determine, based on the signals, a movement direction of the user touch input, the movement direction having a longitudinal component with respect to the longitudinal direction and a lateral component with respect to the lateral direction.

In some examples, the sensor system can determine a first position of a first touch input at a first time step, the first position including a first longitudinal position and a first lateral position. In some examples, the sensor system can determine a second position of a first touch input at a second time step, the second position including a second longitudinal position and a second lateral position. In some examples, the sensor system can determine a movement direction based on the first position at the first time step and the second position at the second time step.

In some examples, the longitudinal component is based, at least in part, on one or more signals from the respective second sensing line for at least one of the first sensing subregion or the second sensing subregion of the flexible substrate. The one or more signals from the respective second sensing line can include a first capacitive response associated with the touch input at the first sensing subregion of the flexible substrate and a different, second capacitive response associated with the touch input at the second sensing subregion of the flexible substrate.

In some examples, the sensor system can determine, based on the signals, the movement direction by determining, based on the movement direction, a movement pattern from at least the first sensing subregion of the flexible substrate or the second sensing subregion of the flexible substrate at a first time step to a different sensing subregion of the flexible substrate at a second time step.

In some examples, the sensor system can determine based on the movement direction of the user touch input, that the user touch input is associated with one or more gestures. The sensor system can initiate one or more actions based at least in part on determining that the touch input is associated with one or more gestures.

The sensor system can determine whether the movement pattern matches a predetermined movement pattern associated with at least one of a lateral swipe gesture or a longitudinal swipe gesture.

In some examples, the sensor system can identify a first lateral swipe gesture based at least in part on the movement direction indicating that the touch input crosses multiple sensing lines in a first lateral direction. The sensor system can identify a second lateral swipe gesture based at least in part on the movement direction indicating that the touch input crosses multiple sensing lines in a second lateral direction.

In some examples, the sensor system can determine that the movement pattern matches the predetermined movement pattern associated with at least one of the lateral swipe gesture or the longitudinal swipe gesture by identifying a first longitudinal swipe gesture based at least in part on the movement direction indicating that the touch input moves along at least one sensing lines in a first longitudinal direction.

In some examples, the sensor system can identify a second longitudinal swipe gesture based at least in part on the movement direction indicating that the touch input moves along at least one sensing line in a second longitudinal direction. The sensor system can determine whether the touch input is associated with the first surface or the second surface based at least in part on the signals generated in response to the touch input by the plurality of second sensing lines. In some examples, at least one action of the one or more actions includes switching the sensor system from a first user context to a second user context.

With reference now to the figures, example aspects of the present disclosure will be discussed in greater detail.

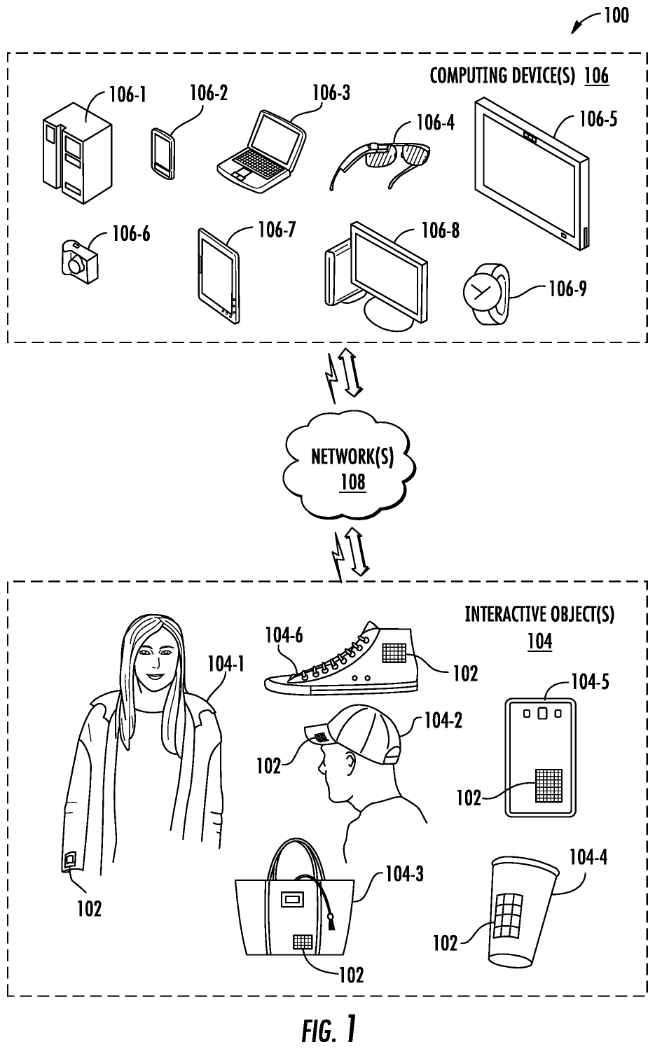

FIG. 1 is an illustration of an example environment 100 in which an interactive object including a touch sensor can be implemented. Environment 100 includes a touch sensor 102 (e.g., capacitive or resistive touch sensor), or other sensor. Touch sensor 102 is shown as being integrated within various interactive objects 104. Touch sensor 102 may include one or more sensing elements such as conductive threads or other sensing lines that are configured to detect a touch input. In some examples, the conductive threads or other sensing lines are arranged to extend parallel to each other along the length of the touch sensor in a longitudinal direction. The conductive threads or other sensing lines can be laterally spaced from each other.

In some examples, a capacitive touch sensor can be formed from an interactive textile which is a textile that is configured to sense multi-touch-input. As described herein, a textile corresponds to any type of flexible woven material consisting of a network of natural or artificial fibers, often referred to as thread or yarn. Textiles may be formed by weaving, knitting, crocheting, knotting, pressing threads together or consolidating fibers or filaments together in a nonwoven manner. A capacitive touch sensor can be formed from any suitable conductive material and in other manners, such as by using flexible conductive lines including metal lines, filaments, etc. attached to a non-woven substrate.

In environment 100, interactive objects 104 include “flexible” objects, such as a shirt 104-1, a hat 104-2, a handbag 104-3 and a shoe 104-6. It is to be noted, however, that touch sensor 102 may be integrated within any type of flexible object made from fabric or a similar flexible material, such as garments or articles of clothing, garment accessories, garment containers, blankets, shower curtains, towels, sheets, bed spreads, or fabric casings of furniture, to name just a few. Examples of garment accessories may include sweat-wicking elastic bands to be worn around the head, wrist, or bicep. Other examples of garment accessories may be found in various wrist, arm, shoulder, knee, leg, and hip braces or compression sleeves. Headwear is another example of a garment accessory, e.g. sun visors, caps, and thermal balaclavas. Examples of garment containers may include waist or hip pouches, backpacks, handbags, satchels, hanging garment bags, and totes. Garment containers may be worn or carried by a user, as in the case of a backpack, or may hold their own weight, as in rolling luggage. Touch sensor 102 may be integrated within flexible objects 104 in a variety of different ways, including weaving, sewing, gluing, and so forth. Flexible objects may also be referred to as “soft” objects.

In this example, objects 104 further include “hard” objects, such as a plastic cup 104-4 and a hard smart phone casing 104-5. It is to be noted, however, that hard objects 104 may include any type of “hard” or “rigid” object made from non-flexible or semi-flexible materials, such as plastic, metal, aluminum, and so on. For example, hard objects 104 may also include plastic chairs, water bottles, plastic balls, or car parts, to name just a few. In another example, hard objects 104 may also include garment accessories such as chest plates, helmets, goggles, shin guards, and elbow guards. Alternatively, the hard or semi-flexible garment accessory may be embodied by a shoe, cleat, boot, or sandal. Touch sensor 102 may be integrated within hard objects 104 using a variety of different manufacturing processes. In one or more implementations, injection molding is used to integrate touch sensors into hard objects 104.

Touch sensor 102 enables a user to control an object 104 with which the touch sensor 102 is integrated, or to control a variety of other computing devices 106 via a network 108. Computing devices 106 are illustrated with various non-limiting example devices: server 106-1, smartphone 106-2, laptop 106-3, computing spectacles 106-4, television 106-5, camera 106-6, tablet 106-7, desktop 106-8, and smart watch 106-9, though other devices may also be used, such as home automation and control systems, sound or entertainment systems, home appliances, security systems, netbooks, and e-readers. Note that computing device 106 can be wearable (e.g., computing spectacles and smart watches), non-wearable but mobile (e.g., laptops and tablets), or relatively immobile (e.g., desktops and servers). Computing device 106 may be a local computing device, such as a computing device that can be accessed over a Bluetooth connection, near-field communication connection, or other local-network connection. Computing device 106 may be a remote computing device, such as a computing device of a cloud computing system.

Network 108 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Touch sensor 102 can interact with computing devices 106 by transmitting touch data or other sensor data through network 108. Additionally or alternatively, touch sensor 102 may transmit gesture data, movement data, or other data derived from sensor data generated by the touch sensor 102. Computing device 106 can use the touch data to control computing device 106 or applications at computing device 106. As an example, consider that touch sensor 102 integrated at shirt 104-1 may be configured to control the user's smartphone 106-2 in the user's pocket, television 106-5 in the user's home, smart watch 106-9 on the user's wrist, or various other appliances in the user's house, such as thermostats, lights, music, and so forth. For example, the user may be able to swipe up or down on touch sensor 102 integrated within the user's shirt 104-1 to cause the volume on television 106-5 to go up or down, to cause the temperature controlled by a thermostat in the user's house to increase or decrease, or to turn on and off lights in the user's house. Note that any type of touch, tap, swipe, hold, or stroke gesture may be recognized by touch sensor 102.

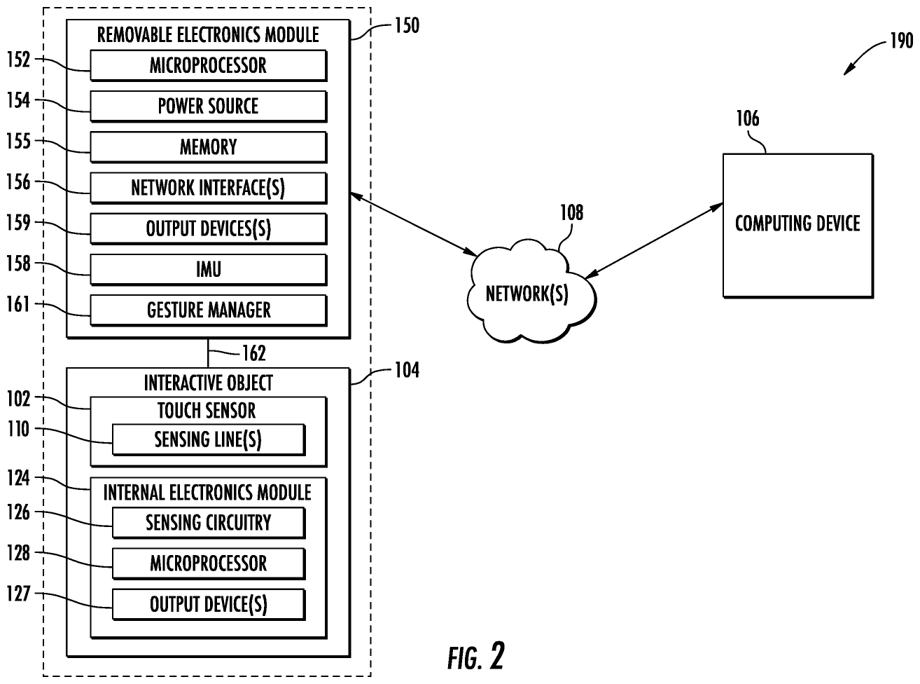

In more detail, consider FIG. 2 which illustrates an example system 190 that includes an interactive object 104, a removable electronics module 150, and a computing device 106. In system 190, touch sensor 102 is integrated in an object 104, which may be implemented as a flexible object (e.g., shirt 104-1, hat 104-2, or handbag 104-3) or a hard object (e.g., plastic cup 104-4 or smart phone casing 104-5).

Touch sensor 102 is configured to sense touch-input from a user when one or more fingers of the user's hand touch or approach touch sensor 102. Touch sensor 102 may be configured as a capacitive touch sensor or resistive touch sensor to sense single-touch, multi-touch, and/or full-hand touch-input from a user. To enable the detection of touch-input, touch sensor 102 includes sensing lines 110. Sensing elements may include various shapes and geometries. In some examples, sensing lines 110 can be formed as a grid, array, or parallel pattern of sensing lines so as to detect touch input. In some implementations, the sensing lines 110 do not alter the flexibility of touch sensor 102, which enables touch sensor 102 to be easily integrated within interactive objects 104.

Interactive object 104 includes an internal electronics module 124 (also referred to as internal electronics device) that is embedded within interactive object 104 and is directly coupled to sensing lines 110. Internal electronics module 124 can be communicatively coupled to a removable electronics module 150 (also referred to as a removable electronics device) via a communication interface 162. Internal electronics module 124 contains a first subset of electronic circuits or components for the interactive object 104, and removable electronics module 150 contains a second, different, subset of electronic circuits or components for the interactive object 104. As described herein, the internal electronics module 124 may be physically and permanently embedded within interactive object 104, whereas the removable electronics module 150 may be removably coupled to interactive object 104.

In system 190, the electronic components contained within the internal electronics module 124 include sensing circuitry 126 that is coupled to sensing lines 110 that form the touch sensor 102. In some examples, the internal electronics module includes a flexible printed circuit board (PCB). The printed circuit board can include a set of contact pads for attaching to the conductive lines. In some examples, the printed circuit board includes a microprocessor. For example, wires from conductive threads may be connected to sensing circuitry 126 using flexible PCB, creping, gluing with conductive glue, soldering, and so forth. In one embodiment, the sensing circuitry 126 can be configured to detect a user-inputted touch-input on the conductive threads that is pre-programmed to indicate a certain request. In one embodiment, when the conductive threads form a tunneled pattern as described herein, sensing circuitry 126 can be configured to also detect the location of the touch-input on sensing line 110, as well as motion of the touch-input. For example, when an object, such as a user's finger, touches sensing lines 110, the position of the touch can be determined by sensing circuitry 126 by detecting a change in capacitance on the sensing lines 110. The touch-input may then be used to generate touch data usable to control a computing device 106. For example, the touch-input can be used to determine various gestures, such as single-finger touches (e.g., touches, taps, and holds), multi-finger touches (e.g., two-finger touches, two-finger taps, two-finger holds, and pinches), single-finger and multi-finger swipes (e.g., swipe up, swipe down, swipe left, swipe right), and full-hand interactions (e.g., touching the textile with a user's entire hand, covering textile with the user's entire hand, pressing the textile with the user's entire hand, palm touches, and rolling, twisting, or rotating the user's hand while touching the textile).

Internal electronics module 124 can include various types of electronics, such as sensing circuitry 126, sensors (e.g., capacitive touch sensors woven into the garment, microphones, or accelerometers), output devices (e.g., LEDs, speakers, or micro-displays), electrical circuitry, and so forth. Removable electronics module 150 can include various electronics that are configured to connect and/or interface with the electronics of internal electronics module 124. Generally, the electronics contained within removable electronics module 150 are different than those contained within internal electronics module 124, and may include electronics such as microprocessor 152, power source 154 (e.g., a battery), memory 155, network interface 156 (e.g., Bluetooth, WiFi, USB), sensors (e.g., accelerometers, heart rate monitors, pedometers, IMUs), output devices (e.g., speakers, LEDs), and so forth.

In some examples, removable electronics module 150 is implemented as a strap or tag that contains the various electronics. The strap or tag, for example, can be formed from a material such as rubber, nylon, plastic, metal, or any other type of fabric. Notably, however, removable electronics module 150 may take any type of form. For example, rather than being a strap, removable electronics module 150 could resemble a circular or square piece of material (e.g., rubber or nylon).

The inertial measurement unit(s) (IMU(s)) 158 can generate sensor data indicative of a position, velocity, and/or an acceleration of the interactive object. The IMU(s) 158 may generate one or more outputs describing one or more three-dimensional motions of the interactive object 104. The IMU(s) may be secured to the internal electronics module 124, for example, with zero degrees of freedom, either removably or irremovably, such that the inertial measurement unit translates and is reoriented as the interactive object 104 is translated and is reoriented. In some embodiments, the inertial measurement unit(s) 158 may include a gyroscope or an accelerometer (e.g., a combination of a gyroscope and an accelerometer), such as a three-axis gyroscope or accelerometer configured to sense rotation and acceleration along and about three, generally orthogonal axes. In some embodiments, the inertial measurement unit(s) may include a sensor configured to detect changes in velocity or changes in rotational velocity of the interactive object and an integrator configured to integrate signals from the sensor such that a net movement may be calculated, for instance by a processor of the inertial measurement unit, based on an integrated movement about or along each of a plurality of axes.

Communication interface 162 enables the transfer of power and data (e.g., the touch-input detected by sensing circuitry 126) between the internal electronics module 124 and the removable electronics module 260. In some implementations, communication interface 162 may be implemented as a connector that includes a connector plug and a connector receptacle. The connector plug may be implemented at the removable electronics module 150 and is configured to connect to the connector receptacle, which may be implemented at the interactive object 104. One or more communication interface(s) may be included in some examples. For instance, a first communication interface may physically couple the removable electronics module 150 to one or more computing devices 106, and a second communication interface may physically couple the removable electronics module 150 to interactive object 104.

In system 190, the removable electronics module 150 includes a microprocessor 152, a power source 154, memory 155, one or more output devices 159, an IMU 158, a gesture manager 161, and network interface 156. Power source 154 may be coupled, via communication interface 162, to sensing circuitry 126 to provide power to sensing circuitry 126 to enable the detection of touch-input, and may be implemented as a small battery. When touch-input is detected by sensing circuitry 126 of the internal electronics module 124, data representative of the touch-input may be communicated, via communication interface 162, to microprocessor 152 of the removable electronics module 150. Microprocessor 152 may then analyze the touch-input data to generate one or more control signals, which may then be communicated to a computing device 106 (e.g., a smart phone, server, cloud computing infrastructure, etc.) via the network interface 156 to cause the computing device to initiate a particular functionality. Generally, network interfaces 156 are configured to communicate data, such as touch data, over wired, wireless, or optical networks to computing devices. By way of example and not limitation, network interfaces 156 may communicate data over a local-area-network (LAN), a wireless local-area-network (WLAN), a personal-area-network (PAN) (e.g., Bluetooth™), a wide-area-network (WAN), an intranet, the Internet, a peer-to-peer network, point-to-point network, a mesh network, and the like (e.g., through network 108 of FIG. 1 and FIG. 2).

Object 104 may also include one or more output devices 127 configured to provide a haptic response, a tactical response, an audio response, a visual response, or some combination thereof. Similarly, removable electronics module 150 may include one or more output devices 159 configured to provide a haptic response, tactical response, and audio response, a visual response, or some combination thereof. Output devices 127 may include visual output devices, such as one or more light-emitting diodes (LEDs), audio output devices such as one or more speakers, one or more tactile output devices, and/or one or more haptic output devices. In some examples, the one or more output devices 159 are formed as part of removable electronics module 150, although this is not required.

In one example, an output device 127 can include one or more LEDs configured to provide different types of output signals. For example, the one or more LEDs can be configured to generate a circular pattern of light, such as by controlling the order and/or timing of individual LED activations. Other lights and techniques may be used to generate visual patterns including circular patterns. In some examples, one or more LEDs may produce different colored light to provide different types of visual indications. Output devices 127 may include a haptic or tactile output device that provides different types of output signals in the form of different vibrations and/or vibration patterns. In yet another example, output devices 127 may include a haptic output device such as may tighten or loosen an interactive garment with respect to a user. For example, a clamp, clasp, cuff, pleat, pleat actuator, band (e.g., contraction band), or other device may be used to adjust the fit of a garment on a user (e.g., tighten and/or loosen). In some examples, an interactive textile may be configured to tighten a garment such as by actuating conductive threads within the touch sensor 102.

A gesture manager 161 can be capable of interacting with applications at computing devices 106 and touch sensor 102 effective to aid, in some cases, control of applications through touch-input received by touch sensor 102. For example, gesture manager 161 can interact with applications. In FIG. 2, gesture manager 161 is illustrated as implemented at removable electronics module 150. It will be appreciated, however, that gesture manager 161 may be implemented at internal electronics module 124, a computing device 106 remote from the interactive object, or some combination thereof. A gesture manager 161 may be implemented as a standalone application in some embodiments. In other embodiments, a gesture manager 161 may be incorporated with one or more applications at a computing device.

A gesture or other predetermined motion can be determined based on touch data detected by the touch sensor 102 and/or an inertial measurement unit 158 or other sensor. For example, gesture manager 161 can determine a gesture based on touch data, such as single-finger touch gesture, a double-tap gesture, a two-finger touch gesture, a swipe gesture, and so forth. As another example, gesture manager 161 can determine a gesture based on movement data such as a velocity, acceleration, etc. as can be determined by inertial measurement unit 158.

A functionality associated with a gesture can be determined by gesture manager 161 and/or an application at a computing device 106. In some examples, it is determined whether the touch data corresponds to a request to perform a particular functionality. For example, the gesture manager 161 can determine whether touch data corresponds to a user input or gesture that is mapped to a particular functionality, such as initiating a vehicle service, triggering a text message or other notification, answering a phone call, creating a journal entry, and so forth. As described throughout, any type of user input or gesture may be used to trigger the functionality, such as swiping, tapping, or holding touch sensor 102. In one or more implementations, a gesture manager 161 can enable application developers or users to configure the types of user input or gestures that can be used to trigger various different types of functionalities. For example, a gesture manager 161 can cause a particular functionality to be performed, such as by sending a text message or other communication, answering a phone call, creating a journal entry, increase the volume on a television, turn on lights in the user's house, open the automatic garage door of the user's house, and so forth.

While internal electronics module 124 and removable electronics module 150 are illustrated and described as including specific electronic components, it is to be appreciated that these modules may be configured in a variety of different ways. For example, in some cases, electronic components described as being contained within internal electronics module 124 may be at least partially implemented at the removable electronics module 150, and vice versa. Furthermore, internal electronics module 124 and removable electronics module 150 may include electronic components other that those illustrated in FIG. 2, such as sensors, light sources (e.g., LED's), displays, speakers, and so forth.

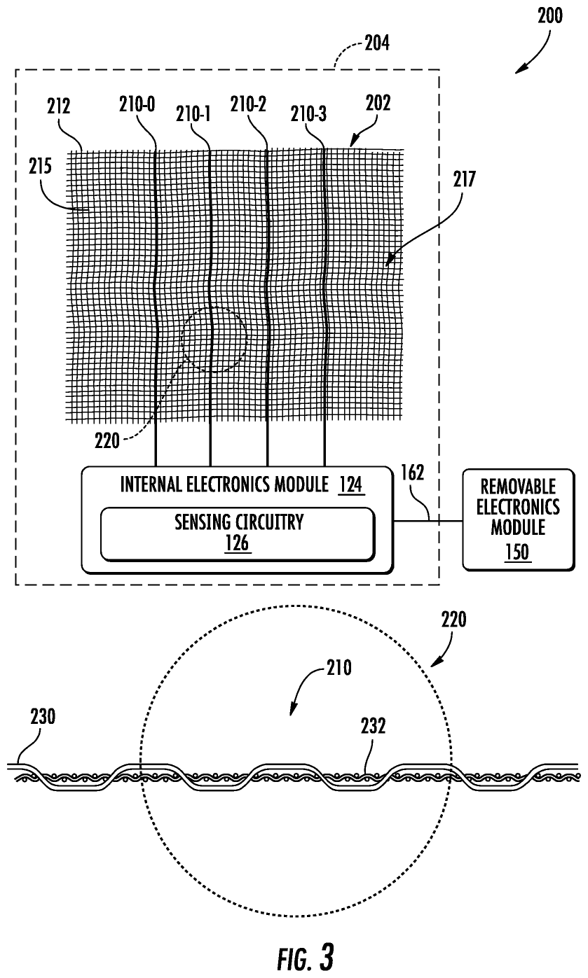

FIG. 3 illustrates an example of a sensor system 200, such as can be integrated with an interactive object 204 in accordance with one or more implementations. In this example, the sensing elements (e.g., sensing lines 110 in FIG. 2) are implemented as conductive threads 210 on or within a substrate 215. Touch sensor 202 includes non-conductive threads 212 woven with conductive threads 210 to form a capacitive touch sensor 202 (e.g., interactive textile). It is noted that a similar arrangement may be used to form a resistive touch sensor. Non-conductive threads 212 may correspond to any type of non-conductive thread, fiber, or fabric, such as cotton, wool, silk, nylon, polyester, and so forth.

At 220, a zoomed-in view of conductive thread 210 is illustrated. Conductive thread 210 includes a conductive wire 230 or a plurality of conductive filaments that are twisted, braided, or wrapped with a flexible thread 232. As shown, the conductive thread 210 can be woven with or otherwise integrated with the non-conductive threads 212 to form a fabric or a textile. Although a conductive thread and textile is illustrated, it will be appreciated that other types of sensing elements and substrates may be used, such as flexible metal lines formed on a plastic substrate.

In one or more implementations, conductive wire 230 is a thin copper wire. It is to be noted, however, that the conductive wire 230 may also be implemented using other materials, such as silver, gold, or other materials coated with a conductive polymer. The conductive wire 230 may include an outer cover layer formed by braiding together non-conductive threads. The flexible thread 232 may be implemented as any type of flexible thread or fiber, such as cotton, wool, silk, nylon, polyester, and so forth.

Capacitive touch sensor 202 can be formed cost-effectively and efficiently, using any conventional weaving process (e.g., jacquard weaving or 3D-weaving), which involves interlacing a set of longer threads (called the warp) with a set of crossing threads (called the weft). Weaving may be implemented on a frame or machine known as a loom, of which there are a number of types. Thus, a loom can weave non-conductive threads 212 with conductive threads 210 to create capacitive touch sensor 202. In another example, capacitive touch sensor 202 can be formed using a predefined arrangement of sensing lines formed from a conductive fabric such as an electro-magnetic fabric including one or more metal layers.

The conductive threads 210 can be formed into the touch sensor 202 in any suitable pattern or array. In one embodiment, for instance, the conductive threads 210 may form a single series of parallel threads. For instance, in one embodiment, the capacitive touch sensor may comprise a single plurality of parallel conductive threads conveniently located on the interactive object, such as on the sleeve of a jacket.

In example system 200, sensing circuitry 126 is shown as being integrated within object 104, and is directly connected to conductive threads 210. During operation, sensing circuitry 126 can determine positions of touch-input on the conductive threads 210 using self-capacitance sensing or mutual capacitive sensing.

For example, when configured as a self-capacitance sensor, sensing circuitry 126 charges can charge a selected conductive thread 210 by applying a control signal (e.g., a sine signal) to the selected conductive thread 210. The control signal may be referred to as a scanning voltage in some examples and the processing of determining the capacitance of a selected conductive thread may be referred to as scanning. In some examples, the control signal can be applied to a selected conductive thread while grounding or applying a low-level voltage to the other conductive threads. When an object, such as the user's finger, touches the grid of conductive thread 210, the capacitive coupling between the conductive thread 210 that is being scanned and system ground may be increased, which changes the capacitance sensed by the touched conductive thread 210. This process can be repeated by applying the scanning voltage to each selected conductive thread while grounding the remaining non-selected conductive threads. In some examples, the conductive threads can be scanned individually, proceeding through the set of conductive threads in sequence. In other examples, more than one conductive thread may be scanned simultaneously.

Sensing circuitry 126 uses the change in capacitance to identify the presence of the object (e.g., user's finger, stylus, etc.). When an object, such as the user's finger, touches the grid of conductive thread, the capacitance changes on the conductive threads (e.g., increases or decreases). Sensing circuitry 126 uses the change in capacitance on conductive threads to identify the presence of the object. To do so, sensing circuitry 126 detects a position of the touch-input by scanning the conductive threads to detect changes in capacitance. Sensing circuitry 126 determines the position of the touch-input based on conductive threads having a changed capacitance. Other sensing techniques such as mutual capacitive sensing may be used in example embodiments.

The conductive thread 210 and sensing circuitry 126 is configured to communicate the touch data that is representative of the detected touch-input to gesture manager 161 (e.g., at removable electronics module 150 in FIG. 2). The microprocessor 152 may then cause communication of the touch data, via network interface 156, to computing device 106 to enable the device to determine gestures based on the touch data, which can be used to control object 104, computing device 106, or applications implemented at computing device 106. In some implementations, a predefined motion may be determined by the internal electronics module and/or the removable electronics module and data indicative of the predefined motion can be communicated to a computing device 106 to control object 104, computing device 106, or applications implemented at computing device 106.

In accordance with some embodiments, a plurality of sensing lines can be formed from a multilayered flexible film to facilitate a flexible sensing line. For example, the multilayered film may include one or more flexible base layers such as a flexible textile, plastic, or other flexible material. One or more metal layers may extend over the flexible base layer(s). Optionally, one or more passivation layers can extend over the one or more flexible base layers and the one or more metal layer(s) to promote adhesion between the metal layer(s) and the base layer(s). In accordance with some examples, a multilayered sheet including one or more flexible base layers, one or more metal layers, and optionally one or more passivation layers can be formed and then cut, etched, or otherwise divided into individual sensing lines. Each sensing line can include a line of the one or more metal layers formed over a line of the one or more flexible base layers. Optionally, a sensing line can include a line of one or more passivation layers overlying the one or more flexible base layers. An electromagnetic field shielding fabric can be used to form the sensing lines in some examples.

The plurality of conductive threads 210 forming touch sensor 202 are integrated with non-conductive threads 212 to form flexible substrate 215 having a first surface 217. opposite a second side (or surface) in a direction orthogonal to the first side and the second side. Any number of conductive threads may be used to form a touch sensor. Moreover, any number of conductive threads may be used to form the plurality of first conductive threads and the plurality of second conductive threads. Additionally, the flexible substrate may be formed from one or more layers. For instance, the conductive threads may be woven with multiple layers of non-conductive threads. In this example, the conductive threads are formed on the first surface only. In other examples, a first set of conductive threads can be formed on the first surface and a second set of conductive threads at least partially formed on the second surface.

One or more control circuits of the sensor system 200 can obtain touch data associated with a touch input to touch sensor 202. The one or more control circuits can include sensing circuitry 126 and/or a computing device such as a microprocessor 128 at the internal electronics module, microprocessor 152 at the removable electronics module 150, and/or a remote computing device 106. The one or more control circuits can implement gesture manager 161 in example embodiments. The touch data can include data associated with a respective response by each of the plurality of conductive threads 210. The touch data can include, for example, a capacitance associated with conductive threads 210-1, 210-2, 210-3, and 210-4. In some examples, the control circuit(s) can determine whether the touch input is associated with a first subset of conductive threads exposed on the first surface or a second subset of conductive threads exposed on the second surface. The control circuit(s) can classify the touch input as associated with a particular subset based at least in part on the respective response to the touch input by the plurality of conductive sensing elements.

The control circuits(s) can be configured to detect a surface of the touch sensor at which a touch input is received, detect one or more gestures or other user movements in response to touch data associated with a touch input, and/or initiate one or more actions in response to detecting the gesture or other user movement. By way of example, control circuit(s) can obtain touch data that is generated in response to a touch input to touch sensor 202. The touch data can be based at least in part on a response (e.g., resistance or capacitance) associated with sensing elements from each subset of sensing elements. The control circuit(s) can determine whether the touch input is associated with a first surface of the touch sensor or a second surface of the touch sensor based at least in part on the response associated with the first sensing element and the response associated with the second sensing element. The control circuit(s) can selectively determine whether a touch input corresponds to a particular input gesture based at least in part on whether the touch input is determined to have been received at first surface of the touch sensor or a second surface of the touch sensor. Notably, the control circuit(s) can analyze the touch data from each subset of sensing elements to determine whether a particular gesture has been performed. In this regard, the control circuits can utilize the individual subsets of elements to identify the particular surface of the touch sensor. However, the control circuits can utilize the full set of sensing elements to identify whether a gesture has been performed.

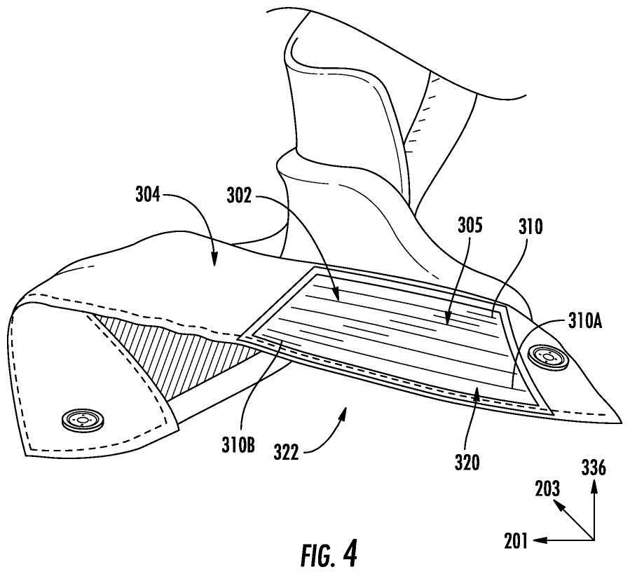

FIG. 4 is a perspective view of an example of an interactive object including a capacitive touch sensor 302 in accordance with example embodiments of the present disclosure. In this example, the interactive object can be an interactive garment 304 having a capacitive touch sensor 302 integrated into the cuff of a sleeve. By way of example, the user can perform a gesture by brushing in on the cuff of the interactive object 104 where the capacitive touch sensor 302 is placed. Gesture manager (e.g., gesture manager 161 in FIG. 2) can be configured to initiate and/or implement one or more functionalities in response to the brush in gesture. For example, a user may perform a brush-in gesture in order to receive a notification related to an application at the remote computing device (e.g., having a text message converted into an audible output at the remote computing device). Note that any type of touch, tap, swipe, hold, or stroke gesture may be recognized by capacitive touch sensor 302. In an alternate example, a resistive touch sensor may be used rather than a capacitive touch sensor.

The conductive sensing lines 310 in FIG. 4 are positioned at a touch sensor area 305. The sensing lines 310 can be partitioned into subsets of sensing lines to enable a sensor system to distinguish the lateral position and the longitudinal position of a touch input. To do so, the sensing lines can be coupled to a flexible substrate. The flexible substrate can include one or more layers. For example, the layers can provide two different surfaces including a first surface and an opposite second surface (e.g., two different sides of the flexible substrate). Furthermore, the flexible substrate can include one or more sensing subregions along its longitudinal axis.

The sensing lines can include a plurality of first sensing lines and a plurality of second sensing lines. The plurality of first sensing lines can be coupled to the first surface (or layer). The plurality of second sensing lines can be coupled to the second surface of the flexible substrate in some sensing subregions and coupled to the first surface of the flexible substrate in other sensing subregions. Typically, the vertical separation between the first and second surfaces (or layers) can be such that the capacitive signal generated by the sensing lines coupled to the first surface can be measurably different from the capacitive signal generated by the sensing lines coupled to the second surface.

The first surface of the flexible substrate can be positioned closer to the intended touch input surface 320 and the second surface can be positioned further from the intended touch input surface 320 and closer to the second surface 322 which will be adjacent to the user when worn. For example, the first surface can be adjacent to the intended touch input surface and the second surface can be adjacent to one or more portions of the user's body when the interactive garment is worn by the user. In some embodiments, the first surface of the flexible substrate and the second surface of the flexible substrate can be separated in the direction orthogonal to the first surface and the second surface of the flexible substrate. By positioning the plurality of first sensing lines on the first surface of the flexible substrate and the second sensing lines selectively on either the first surface or the second surface of the flexible substrate, the longitudinal position of the touch input can be determined based on the capacitive signal.

In accordance with example embodiments, the plurality of first sensing lines and the plurality of second sensing lines can be arranged in parallel and laterally separated. In addition, the sensing lines can be arranged such that the sensing lines alternate between a first sensing line and a second sensing line. For example, the sensing elements can be arranged as parallel sensing lines as shown in FIG. 4. The sensing lines can be elongated in a longitudinal direction 201 with a separation therebetween in a lateral direction 203 orthogonal to the longitudinal direction 201. Notably, this separation can be provided with or without the use of a flexible substrate to which the lines are coupled. A touch input provided at the intended touch input surface (e.g., +vertical axis) can generate a stronger signal (e.g., capacitance) for sensing lines coupled to the first surface than lines coupled to the second surface. A touch input provided at the second surface (e.g., −vertical axis) can generate a stronger signal (e.g., capacitance) on the sensing lines coupled to the second surface of the flexible substrate.

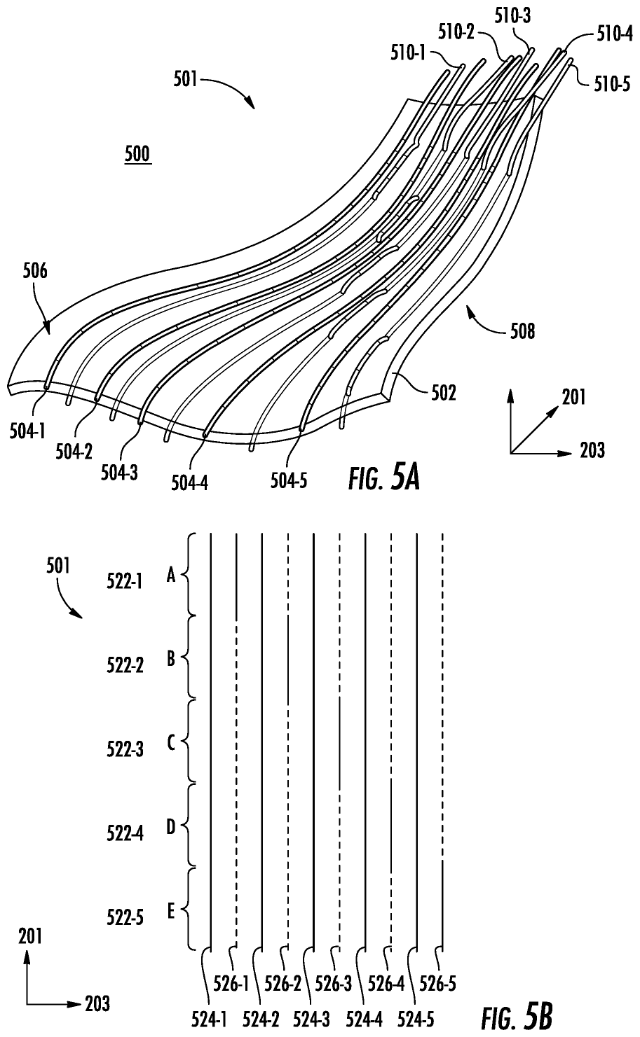

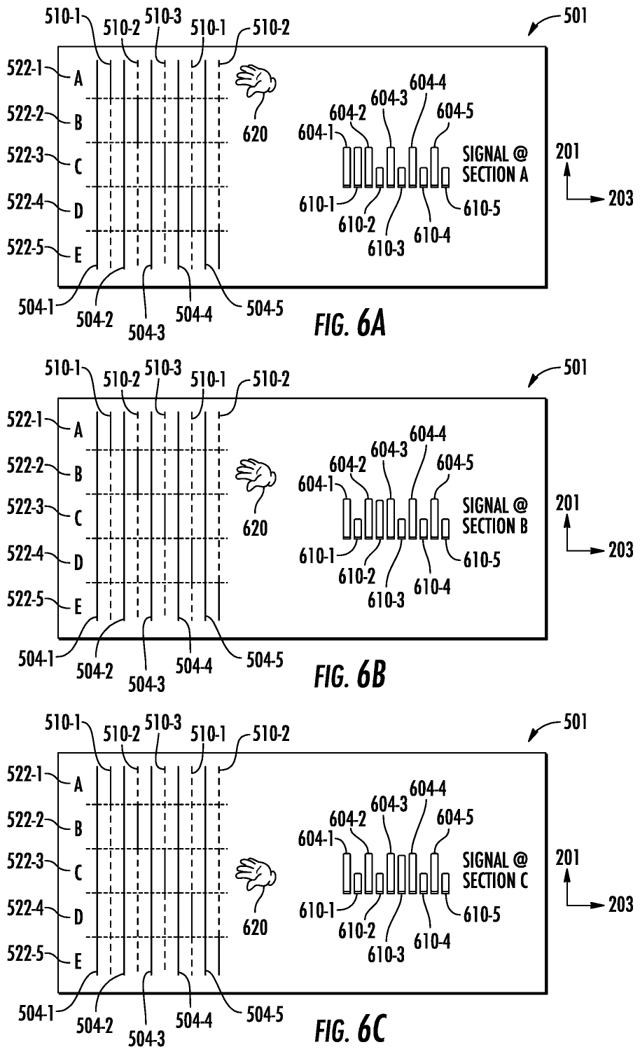

FIG. 5A is a diagram representing a touch sensor 500 with conductive sensing lines that can be coupled to either a first or second surface of a flexible substrate in accordance with example embodiments of the present disclosure. In this example, a sensing region 501 is provided at a flexible substrate 502, including a plurality of first sensing lines 504-1 to 504-5, and a plurality of second sensing lines 510-1 to 510-5. The sensing lines are elongated in the longitudinal direction 201 with a spacing therebetween in the lateral direction 203. The flexible substrate 502 has a first surface 506 and a second opposite surface 508 (which is not directly shown in this figure.). In some examples, the first surface 506 can be the top or upper side of the flexible substrate 502 and the second surface 508 can be the bottom or underside of the flexible substrate 502.

In this diagram, the sensing lines can be coupled to either the first surface (the top side) of the flexible substrate or a second surface (the bottom side) of the flexible substrate. The plurality of first sensing lines 504 are coupled to the first surface 506 of the flexible substrate 502. The plurality of second sensing lines 510 can be selectively coupled to either the first surface 506 of the flexible substrate 502 or the second surface 508 of the flexible substrate 502 depending on which sensing subregion the second sensing line is in. In some examples, the second sensing lines 510 are arranged such that a unique pattern of second sensing lines 510 are coupled to the first surface of the flexible substrate 502 in each sensing subregion of the flexible substrate 502.

A simple example can include, for each sensing subregion, a single second sensing line 510 that is coupled to the first surface 506 of the flexible substrate 502. Each sensing subregion can include a unique pattern of second sensing lines 510 such that the signals produced by the sensing lines can be used to determine which sensing subregion the touch input was received in.

FIG. 5B is a top view depicting touch sensor 500 including conductive sensing lines coupled to either a first or second surface of a flexible substrate in accordance with example embodiments of the present disclosure. In the top view of FIG. 5B, the sensing region 501 is divided into five sensing subregions 522-1 to 522-5 denoted A-E. While the subregions are denoted as defined areas of the substrate, it will be appreciated that the subregions can be naturally defined by the placement of the second sensing lines at the first surface as hereinafter described.

In FIG. 5B, the plurality of sensing lines are elongated in the longitudinal direction 201 and are spaced apart in the lateral direction 203. The first surface and the second surface are separated in the vertical direction, orthogonal to the longitudinal direction 201 and lateral directions 203. The plurality of first sensing lines 504-1 to 504-4 and the plurality of second sensing lines 510-1 to 510-4 are formed substantially in parallel. In this example, portions of sensing lines that are represented by solid lines indicate that the associated portion of the sensing line is coupled to the first surface of the flexible substrate 502 and portions of sensing lines that are represented by dotted lines indicate that the associated portion of the sensing line is coupled to the second surface of the flexible substrate 502.

In some examples, the plurality of first sensing lines can be coupled to the first surface in all subregions of the flexible substrate. In contrast, the plurality of second sensing lines can be coupled to the first surface in some subregions of the flexible substrate and coupled to the second surface in other subregions of the flexible substrate. For example, the second sensing line 526-1 can be coupled to the first surface of the flexible substrate in sensing subregion A 522-1 and coupled to the second surface in all other subregions. Similarly, second sensing line 526-2 is coupled to the first surface of the flexible substrate in sensing subregion B 522-2 and coupled to the second surface in all other subregions, second sensing line 526-3 is coupled to the first surface of the flexible substrate in sensing subregion C 522-3 and coupled to the second surface in all other subregions, and second sensing line 526-4 is coupled to the first surface of the flexible substrate in sensing subregion D 522-4 and coupled to the second surface in all other subregions. By having a layout of the sensing lines such that each subregion has a unique pattern of second sensing lines coupled to the first surface, a touch sensor can, based on the resulting signals generated by the touch input, determine which subregion receives the touch input. For example, a user touch input along the sensing lines in the longitudinal direction 201 can be detected by detecting the touch at individual sensing subregions due to select exposure of the second sensing lines at the first surface.

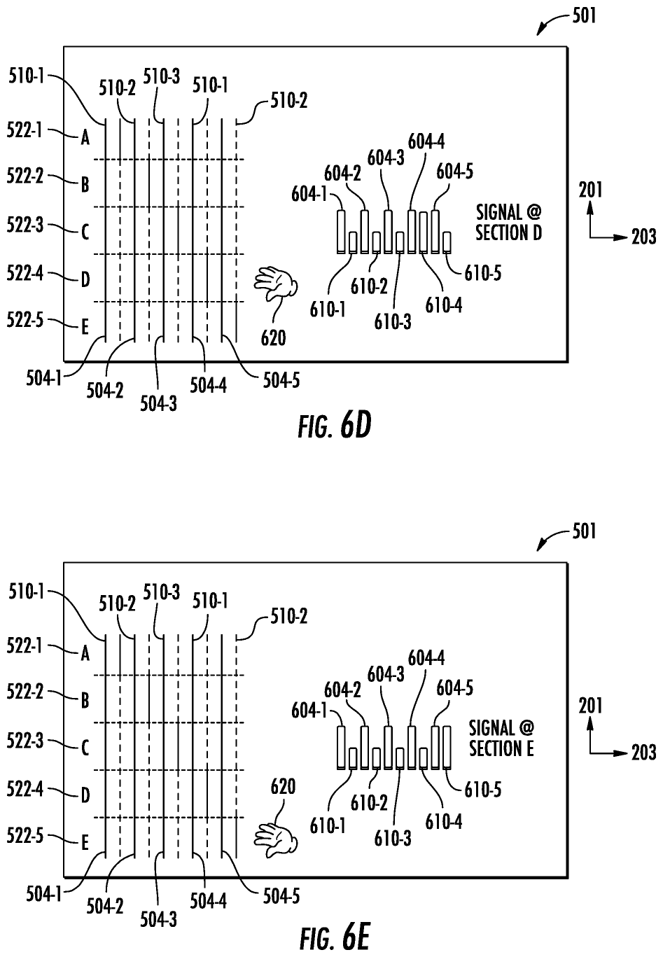

FIGS. 6A-6E are diagrams representing a touch sensor with conductive sensing lines that can be coupled to either a first or second surface of a flexible substrate in accordance with example embodiments of the present disclosure. A touch sensor can include a sensing region 501 that includes a plurality of sensing subregions A-E (522-1 to 522-5) and a plurality of sensing lines. The plurality of sensing lines includes a plurality of first sensing lines 504-1 to 504-5. The first sensing lines 504-1 to 504-5 can be coupled to the first surface of the flexible substrate in all sensing subregions. The plurality of sensing lines also includes a plurality of second sensing lines 510-1 to 510-5). The second sensing lines can be selectively coupled to the first surface in some sensing subregions and the second surface in other sensing subregions.

FIGS. 6A-6E depict example signals produced by the sensing lines as a touch input 620 (e.g., represented by the hand object) moves from sensing subregion A to sensing subregion E by passing through the other sensing subregions in accordance with example embodiments of the present disclosure. Such a touch input can be created by a swipe gesture from the subregion A 522-1 to subregion E 522-5.

In FIG. 6A, the touch input 620 can first be detected at subregion A 522-1. In response, the signals 604-1 to 604-5 detected on the plurality of first sensing lines 504-1 to 504-5 include a high capacitance value because the first sensing lines are all coupled to the first surface 506 of the flexible substrate in sensing subsection A 522-1. Second sensing line 510-1, which is also coupled to the first surface 506 generates a capacitive signal value as shown by signal 610-1, similar to those produced by the plurality of first sensing lines. The other second sensing lines (510-2, 510-3, and 606-4) produce a reduced signal response as shown by signals 610-2, 610-3, 610-4, and 610-5 because they are coupled to the second surface of the flexible substrate with further separation from the touch input in the vertical direction.

In some examples, a touch sensor can determine that touch input was received at sensing subsection A 522-1 based on the signal response of the second sensing lines. In some examples, the touch sensor can compare the response signals of the second sensing lines to a fixed threshold value. Based on determining which second sensing line exceeds the fixed threshold value, the touch sensor can identify the sensing subsection at which the touch input was received. In another example, the touch sensor can compare the signals produced by the second sensing lines to the signals produced by the first sensing lines. The touch sensor can determine, for each respective second sensing line, whether the signal produced (e.g., 610-1 for sensing line 510-1) is within a threshold amount from the average signal produced by the first sensing lines 504-1 to 504-5 (or the signal values of the first sensing lines adjacent to the respective second sensing line). In this example, the touch sensor identifies that the touch input was received at sensing subregion A 522-1.

In FIG. 6B, the touch input (e.g., a finger) has moved to sensing subregion B 522-2 (e.g., a swipe gesture started in sensing subregion A 522-1 and moved to B 522-2). As a result, the signal 610-1 from second sensing line 510-1 has dropped to the lower value (as it is now coupled to the second surface) and the signals 610-2 for second sensing line 510-2 has increased to a higher value. The other second sensing line signal values can remain relatively low, while the signal 604-1 to 604-5 for the first sensing lines remain at a high value. The touch sensor can identify that the touch input has moved to sensing subregion B 522-2.

In FIG. 6C, the touch input (e.g., a finger) has moved to sensing subregion C 522-3 (e.g., the swipe gesture started in sensing subregion A 522-1, moved through subregion B 522-2, and is now in sensing subregion C 522-3). As a result, the signal 610-2 from second sensing line 510-2 has dropped to the lower value (as it is now coupled to the second surface) and the signal 610-3 for second sensing line 510-3 has increased to a higher value. The other second sensing line signal values can remain relatively low, while the signals 604-1 to 604-5 for the first sensing lines remain at a high value. The touch sensor can identify that the touch input has moved to sensing subregion C 522-3.

In FIG. 6D, the touch input (e.g., a finger) has moved to sensing subregion D 522-4 (e.g., the swipe gesture started in sensing subregion A 522-1, moved through subregions B 522-2 and C 522-3, and is now in sensing subregion D 522-4). As a result, the signal 610-3 from second sensing line 510-3 has dropped to the lower value (as it is now coupled to the second surface) and the signal 610-4 for second sensing line 510-4 has increased to a higher value. The other second sensing line signal values can remain relatively low, while the signals 604-1 to 604-5 for the first sensing lines remain at a high value. The touch sensor can identify that the touch input has moved to sensing subregion D 522-4.

In FIG. 6E, the touch input (e.g., a finger) has moved to sensing subregion E 522-5 (e.g., the swipe gesture started in sensing subregion A 522-1, moved through subregions B 522-2, C 522-3, and D 522-4, and is now in sensing subregion E 522-5). As a result, the signal 610-4 from second sensing line 510-4 has dropped to the lower value (as it is now coupled to the second surface) and the signal 610-5 for second sensing line 510-5 has increased to a higher value. The other second sensing line signal values can remain relatively low, while the signal values for the first sensing lines 504-1 to 504-5 remain at a high value. The touch sensor can identify that the touch input has moved to sensing subregion E 522-5.

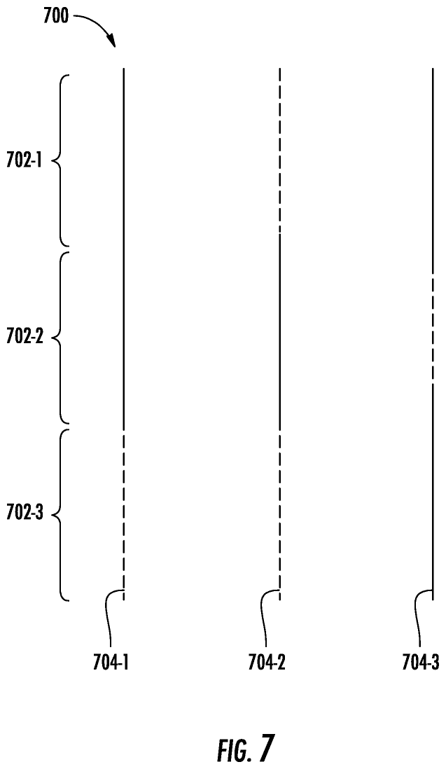

FIG. 7 is a graphical diagram illustrating a set of sensing lines coupled to a first surface of a flexible substrate in different patterns along its longitudinal length in accordance with example embodiments of the present disclosure. A flexible substrate (not shown) and a plurality of sensing lines define a sensing region for a touch sensor. In this example, all of the sensing lines (rather than just a subset of the sensing lines) are selectively coupled to either the first surface or the second surface of the flexible substrate. Each sensing line is represented by a solid line where the sensing line is coupled to the first surface and is represented by a dotted line where the sensing line is coupled to the second surface.

Sensing region 700 is divided into three sensing subregions 702-1, 702-2, and 702-3. Sensing line 704-1 is coupled to the first surface of the flexible substrate in a first sensing subregion 702-1 and a second sensing subregion 702-2 and is coupled to the second surface of the flexible substrate in a third sensing subregion 702-3.

Sensing line 704-2 is coupled to the first surface of the flexible substrate in a second sensing subregion 702-2 and is coupled to the second surface of the flexible substrate in a first sensing subregion 702-1 and a third sensing subregion 702-3.

Sensing line 704-is coupled to the first surface of the flexible substrate in a first sensing subregion 702-1 and a third sensing subregion 702-3 and coupled to the second surface of the flexible substrate in a third sensing subregion 702-2.

When a touch input is received in one of the three sensing subregions (702-1, 702-2, or 702-3), the sensing lines 704-1, 704-2, 704-3 will generate signal values based, at least in part, on whether they are coupled to the first surface or the second surface of the flexible substrate at the sensing subregion where the touch input was received. As such, the signals produced by the three sensing lines 704-1, 704-2, 704-3 in a particular sensing subregion are distinguishable from the signals produced by the three sensing lines 704-1, 704-2, 704-3 in any other sensing subregion. As such, the touch sensor can use the signals produced by the three sensing lines 704-1, 704-2, 704-3 to determine which sensing subregion the touch input was received in. The touch sensor can determine the longitudinal component of the location of the touch input based on determining which sensing subregion the touch input was received at.

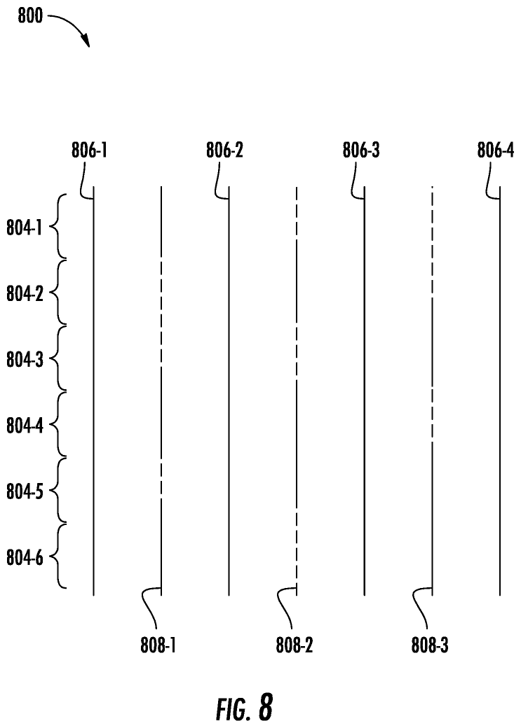

FIG. 8 is a graphical diagram illustrating a set of sensing lines coupled to a first surface of a flexible substrate in different patterns along its longitudinal length in accordance with example embodiments of the present disclosure. FIG. 8 depicts a particular example illustrating that a second sensing line may be exposed at multiple locations on the first surface and that multiple second sensing lines may be exposed at the second surface within the same sensing subregion. In this example, a sensing region 800 is defined by a flexible substrate (not shown) and a plurality of sensing lines arranged in parallel and laterally spaced. The sensing region can include a plurality of subregions (804-1 to 804-6). The plurality of sensing lines can include a plurality of first sensing lines 806-1, 806-2, 806-3, and 806-4. The first sensing lines can be coupled to a first surface of the flexible substrate in all the sensing subregions of the flexible substrate. Each sensing line is represented by a solid line where it is exposed on the first surface and is represented by a dotted line where it is exposed on the second surface.

The plurality of sensing lines can include a plurality of second sensing lines 808-1, 808-2, and 808-3. The second sensing lines can be fabricated such that each sensing subregion is associated with a unique pattern of second sensing lines coupled to the first surface. For example, sensing subregion 804-1 can be associated with second sensing line 808-1 being coupled to or otherwise exposed at the first surface of the flexible substrate and the other second lines being exposed at the second surface. Sensing subregion 804-2 can be associated with the exposure of second sensing line 808-2 at the first surface of the flexible substrate and the other second lines being exposed at the second surface. Sensing subregion 804-3 can be associated with second sensing line 808-3 being coupled to the first surface of the flexible substrate. Sensing subregion 804-4 can be associated with second sensing line 808-1 and second sensing line 808-2 being coupled to the first surface of the flexible substrate. Sensing subregion 804-5 can be associated with second sensing line 808-1 and second sensing line 808-3 being coupled to the first surface of the flexible substrate. Sensing subregion 804-6 can be associated with second sensing line 808-2 and second sensing line 808-3 being coupled to the first surface of the flexible substrate.

In some examples, one or more control circuits can convert signals associated with sensing lines into a binary form based on whether the signal value generated by the sensing line exceeds a threshold value. These binary values can be used to identify the specific sensing subregion at which the touch input was received. In some examples, the binary values can be used as a key in a look-up table. The look-up table can associate specific binary values with a particular sensing subregion. In one example, the control circuits can generate a binary value of “011.” In this example, the binary value “011” can be associated with sensing subregion F (because the sensing line 808-1 is associated with the second surface and sensing lines 808-2 and 808-3 are associated with the first surface of the flexible substrate).

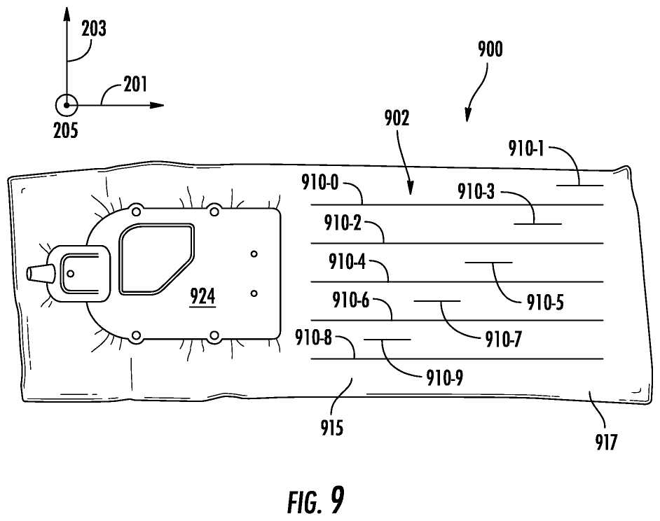

FIG. 9 depicts an example of a touch sensor including individual subsets of sensing lines coupled to surfaces of a flexible substrate in accordance with example embodiments of the present disclosure. A sensor assembly 900 includes a touch sensor 902 and an internal electronics module 924. Internal electronics module 924 is one example of an internal electronics module 124 as depicted in FIG. 2. Touch sensor 902 is one example of a touch sensor 102, as illustrated in FIGS. 1 and 2, and can be configured as a capacitive touch sensor or resistive touch sensor in example embodiments.

Touch sensor 902 is formed from a plurality of conductive threads 910-0 to 910-9. Conductive threads 910-0 to 910-9 are one example of sensing lines 110. Conductive threads 910-0 to 910-9 are an example of parallel sensing lines coupled to a substrate and extending in a longitudinal direction to receive touch input. Internal electronics module 924 may include sensing circuitry (not shown) in electrical communication with the plurality of conductive threads 910-0 to 910-9. Internal electronics module 924 may include one or more communication ports that can couple to a communications cable to provide communication with a removable electronics module. A communication port can additionally or alternatively be coupled to a communication cable to provide communication with various input and/or output devices. Output devices may include an audible output device such as a speaker, a visual output device such as a light (e.g., LED), or a haptic output device such as a haptic motor. Any suitable type of output device may be provided as an output device.

The set of conductive threads 910 can be woven or otherwise integrated with a plurality of non-conductive threads to form an interactive textile substrate 915. More particularly, the conductive threads 910 can be formed on opposite sides of substrate 915. A plurality of first conductive threads 910-0, 910-2, 910-4, 910-6, and 910-8 can be woven with or otherwise coupled to the first surface 917 of the interactive textile and a plurality of second conductive threads 910-1, 910-3, 910-5, 910-7, and 910-9 can be selectively woven with or otherwise coupled to the second surface or the first surface of the interactive textile. The first threads can be formed on the first surface 917 of a flexible substrate adjacent to the first surface of the touch sensor and the second conductive threads can be formed such that it is selectively coupled to either the first surface or the second surface of the flexible substrate adjacent to a second surface of the touch sensor. A touch input to the touch sensor can be detected by the plurality of conductive threads using sensing circuitry of internal electronics module 924 connected to the one or more conductive threads. The sensing circuitry can generate touch data (e.g., raw sensor data or data derived from the raw sensor data) based on the touch input. The sensing circuitry and/or other control circuitry (e.g., a local or remote processor) can analyze the touch data to determine a surface of the touch sensor associated with the touch input. In some examples, the control circuitry can ignore touch inputs associated with the second surface, while analyzing touch inputs associated with the first surface to detect one or more predetermined gestures. As another example, the control circuitry can analyze touch inputs for any of a set of predetermined gestures.

With reference to FIG. 9, the first surface 917 of flexible substrate 915 can correspond to an intended touch input surface for the touch sensor when integrated with an interactive object. For example, sensor assembly 900 can be integrated with an object to form an interactive object having a touch input surface adjacent to the first surface 917 of substrate 915.

Conductive threads 910-0 to 910-9 can be formed on or within the textile-based substrate 915. By way of example, textile-based substrate 915 may be formed by weaving, embroidering, stitching, or otherwise integrating conductive threads 910-0 to 910-9 with a set of nonconductive threads.

The conductive threads are coupled to a connecting ribbon 914 in some examples, which can be utilized to position the conductive lines for connection to a plurality of electrical contact pads (not shown) of internal electronics module 924. The plurality of conductive threads 910-1 to 910-9 can be collected and organized using a ribbon with a pitch that matches a corresponding pitch of connection points of an electronic component such as a component of internal electronics module 924. It is noted, however, that a connecting ribbon is not required.

The first conductive threads 910-0, 910-2, 910-4, 910-6, and 910-8 extend in longitudinal direction 201 with a spacing therebetween in the lateral direction 203. More particularly, the first conductive threads can be coupled to the first surface 917 of flexible substrate 915. The first subset of conductive threads can be coupled to the first surface of the flexible substrate using any suitable technique. For example, flexible substrate 915 can be formed by weaving non-conductive threads with conductive threads 910. In another example, the first subset of conductive threads 910 can be embroidered to the first side of flexible substrate 915. Other techniques such as gluing, heat pressing, or other fastening techniques may be used.

The second subset of conductive threads 910-1, 910-3, 910-5, 910-7, and 910-9 extend from the connecting ribbon on the first surface 917 of the flexible substrate for a limited distance. The second subset of conductive threads extends through the flexible substrate such that they are at least partially exposed on the second side of the flexible substrate. In some examples, the portion of the second subset of conductive threads at the first side can be loose or otherwise not coupled to the flexible substrate 915. In other examples, the second subset of conductive threads can be attached to the first side of flexible substrate 915 before passing through the flexible substrate to the second side 919. At the second side, conductive threads 910-1, 910-3, 910-5, 910-7, and 910-9 extend in the longitudinal direction. The second subset of conductive threads can be coupled to the second side of the flexible substrate using any suitable technique such as those earlier described with the first step such as conductive threads.

A similar pre-fabricated sensor assembly may additionally or alternatively include other types of sensors. For example, a capacitive touch sensor utilizing a thin film conductive material may be utilized in place of conductive thread. In some examples, resistive touch sensors can be formed in a similar manner to capacitive touch sensors as described.

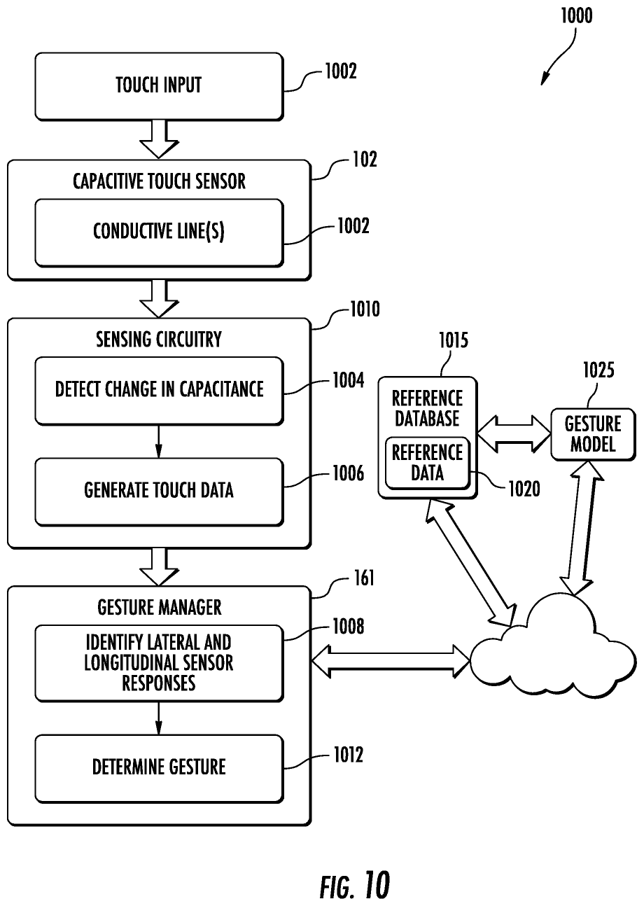

FIG. 10 is a block diagram depicting an example computing environment 1000, illustrating the detection of gestures based on an identified input location of a touch sensor in accordance with example embodiments of the present disclosure.

Interactive object 104 and/or one or more computing devices in communication with interactive object 104 can detect a user gesture based at least in part on capacitive touch sensor 102. For example, interactive object 104 and/or the one or more computing devices can implement a gesture manager 161 that can identify one or more gestures in response to touch input 1002 to the capacitive touch sensor 102.

Interactive object 104 can detect touch input 1002 to capacitive touch sensor 102 based on a change in capacitance associated with a set of conductive threads 210. For example, a user can move an object (e.g., finger, conductive stylus, etc.) proximate to or touch capacitive touch sensor 102, causing a response by the individual sensing elements. By way of example, the capacitance associated with each sensing element can change when an object touches or comes in proximity to the sensing element. As shown at (1004), sensing circuitry 126 can detect a change in capacitance associated with one or more of the sensing elements. Sensing circuitry 126 can generate touch data at (1006) that is indicative of the response (e.g., change in capacitance) of the sensing elements to the touch input. The touch data can include one or more touch input features associated with touch input 1002. In some examples, the touch data may identify a particular element, and an associated response such as a change in capacitance. In some examples, the touch data may indicate a time associated with an element response.

Gesture manager 161 can analyze the touch data to identify the one or more touch input features associated with touch input 1002. Gesture manager 161 can be implemented at interactive object 104 (e.g., by one or more processors of internal electronics module 124 and/or removable electronics module 206) and/or one or more computing devices remote from the interactive object 104.

Gesture manager 161 can analyze the touch data at (1008) to identify lateral and longitudinal sensor responses. By way of example, gesture manager 161 can determine at least one signal difference associated with a sensing line in a plurality of first conductive sensing elements coupled to a first surface of the flexible substrate and one signal difference associated with a sensing line in a plurality of second conductive sensing elements coupled to either a first or second surface of the flexible substrate. If the signal difference of the sensing line in a plurality of second conductive sensing elements is within a predetermined threshold range of the signal difference of the sensing line in a plurality of first conductive sensing elements, the gesture manager 161 can determine that the touch input is associated with a first sensing subregion of the flexible substrate rather than a second sensing subregion. However, if the signal difference exceeds a predetermined threshold value, the gesture manager 161 can determine that the touch input was received at the second sensing subregion.

In accordance with some implementations, the one or more control circuits can analyze a respective response such as a resistance or capacitance of each sensing element of the touch sensor to determine whether a touch input is associated with a first sensing subregion of the touch sensor or a second subregion of the touch sensor.

Gesture manager 161 can determine a gesture based at least in part on the touch data. In some examples gesture manager 161 may identify a particular gesture based on the surface of which the touch input is received. For example, a first gesture may be identified in response to a touch input at a first surface while a second gesture may be identified in response to a touch input at a second surface.

In some examples, gesture manager 161 can identify at least one gesture based on reference data 1020. Reference data 1020 can include data indicative of one or more predefined parameters associated with a particular input gesture. The reference data 1020 can be stored in a reference database 1015 in association with data indicative of one or more gestures. Reference database 1015 can be stored at interactive object 104 (e.g., internal electronics module 124 and/or removable electronics module 206) and/or at one or more remote computing devices in communication with the interactive object 104. In such a case, interactive object 104 can access reference database 1015 via one or more communication interfaces (e.g., network interface 162).

Gesture manager 161 can compare the touch data indicative of the touch input 1002 with reference data 1020 corresponding to at least one gesture. For example, gesture manager 161 can compare touch input features associated with touch input 1002 to reference data 1020 indicative of one or more pre-defined parameters associated with a gesture. Gesture manager 161 can determine a correspondence between at least one touch input feature and at least one parameter. Gesture manager 161 can detect a correspondence between touch input 1002 and at least one line gesture identified in reference database 1015 based on the determined correspondence between at least one touch input feature and at least one parameter. For example, a similarity between the touch input 1002 and a respective gesture can be determined based on a correspondence of touch input features and gesture parameters.

In some examples, gesture manager 161 can input touch data into one or more machine learned gesture models 1025. A machine-learned gesture model 1025 can be configured to output a detection of at least one gesture based on touch data and/or an identification of a surface or subset of sensing element associated with a touch input. Machine learned gesture models 1025 can generate an output including data indicative of a gesture detection. For example, machine learned gesture model 1025 can be trained, via one or more machine learning techniques, using training data to detect particular gestures based on touch data. Similarly, a machine learned gesture model 1025 can be trained, via one or more machine learning techniques, using training data to detect a surface associated with a touch input.

Gesture manager 161 can input touch data indicative of touch input 1002 and/or into machine learned gesture model 1025. One or more gesture models 1025 can be configured to determine whether the touch input is associated with a first subset of sensing elements or a second subset of sensing elements. Additionally or alternatively, one or more gesture models 1025 can be configured to generate one or more outputs indicative of whether the touch data corresponds to one or more input gestures. Gesture model 1025 can output data indicative of a particular gesture associated with the touch data. Additionally, or alternatively, gesture model 1025 can output data indicative of a surface associated with the touch data. Gesture model 1025 can be configured to output data indicative of an inference or detection of a respective gesture based on a similarity between touch data indicative of touch input 1002 and one or more parameters associated with the gesture.

In accordance with examples embodiments, a sensor system can selectively determine whether a touch input corresponds to a particular input gesture based at least in part on whether the touch input is determined to have been received at a first sensing subregion of the flexible substrate or a second subregion of the flexible substrate. In response to determining that the touch input is associated with the first subregion, the sensor system can determine whether the touch data corresponds to one or more gestures or other predetermined movements. For example, the sensor system can compare the touch data with reference data representing one or more predefined parameters to determine if the touch data corresponds to one or more gestures. In response to detecting the first input gesture, the sensor system can initiate a functionality at a computing device. In response to determining that the touch input is associated with the second surface, however, the sensor system can automatically determine that the touch input is not indicative of the particular input gesture such that a functionality is not initiated.

In some implementations, a touch input at the first surface of the touch sensor can be associated with a first input gesture while the same or a similar touch input at a second surface of the touch sensor can be associated with a second input gesture. For example, the sensor system can determine whether touch data generated in response to a touch input is associated with the first surface of the touch sensor or the second surface of the touch sensor. Additionally, the sensor system can determine whether the touch data corresponds to one or more predefined parameters. If the touch data corresponds to the one or more predefined parameters and is associated with the first sensing subregion the sensor system can determine that a first input gesture has been performed. If, however, the touch data corresponds to the one or more predefined parameters and is associated with the second sensing subregion, the sensor system can determine that a second input gesture has been performed. By differentiating the sensing subregion at which an input is received, the sensor system can detect a larger number of input gestures in example embodiments.

Interactive object 104 and/or a remote computing device in communication with interactive object 104 can initiate one or more actions based on a detected gesture. For example, the detected gesture can be associated with a navigation command (e.g., scrolling up/down/side, flipping a page, etc.) in one or more user interfaces coupled to interactive object 104 (e.g., via the capacitive touch sensor 102, the controller, or both) and/or any of the one or more remote computing devices. In addition, or alternatively, the respective gesture can initiate one or more predefined actions utilizing one or more computing devices, such as, for example, dialing a number, sending a text message, playing a sound recording etc.

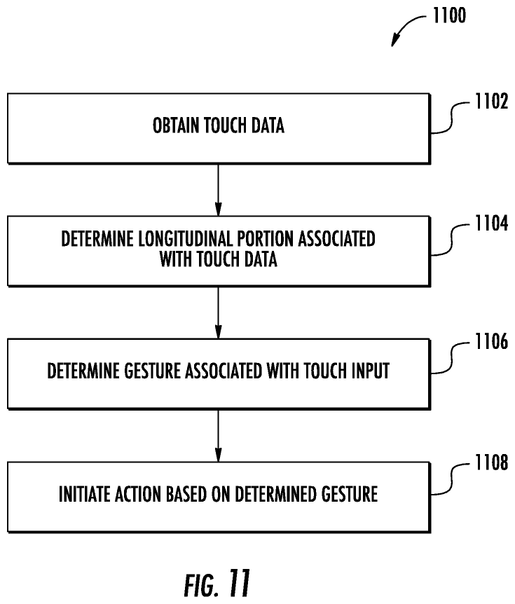

FIG. 11 is a flowchart depicting an example process of generating touch data in response to touch input detected by a touch sensor in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-2 and 10.

In some examples, the sensor system is integrated with a wearable device. In some examples, the sensor system is a capacitive touch sensor. In some examples, a sensor system (e.g., sensor system 200 in FIG. 3) can include a flexible substrate having a first surface and an opposite, second surface, the flexible substrate defining a longitudinal direction and a lateral direction perpendicular to the longitudinal direction. The flexible substrate can include a first sensing subregion and a second sensing subregion.

The sensor system can include a plurality of first sensing lines extending in the longitudinal direction of the flexible substrate and being substantially parallel and spaced apart in the lateral direction, wherein each of the plurality of first sensing lines is coupled to the first surface of the flexible substrate within a sensing region having a length in the longitudinal direction.

The sensor system can also include a plurality of second sensing lines extending in the longitudinal direction of the flexible substrate and substantially parallel with the plurality of first sensing lines, wherein at least a portion of each of the plurality of second sensing lines is exposed on the first surface of the flexible substrate within the sensing region and at least a second portion of each of the plurality of second sensing lines is exposed on the second surface of the flexible substrate within the sensing region. In some examples, the plurality of first sensing lines are approximately equally spaced apart in the lateral direction. In some examples, each of the plurality of second sensing lines can be arranged between a respective pair of first sensing lines such that the first sensing lines alternate with the second sensing lines in the lateral direction.

In some examples, the sensor system can include a respective second sensing line that is coupled to the first surface of the flexible substrate at the first sensing subregion of the flexible substrate and coupled to the second surface of the flexible substrate at the second sensing subregion of the flexible substrate.

In some examples, the sensor system can include, as part of the flexible substrate, a third sensing subregion. A respective first sensing line can be coupled to the first surface of the flexible substrate at the first sensing subregion, the second sensing subregion, and the third sensing subregion of the flexible substrate. A respective second sensing line can be coupled to the second surface of the flexible substrate at the first sensing subregion and the third sensing subregion of the flexible substrate and is coupled to the first surface at the second sensing subregion of the flexible substrate.

In some examples, a respective first sensing line can be coupled to the first surface at the first sensing subregion and the second sensing subregion and is coupled to the second surface at the third sensing subregion of the flexible substrate. A respective second sensing line can be coupled to the first surface of the flexible substrate at the first sensing subregion and the third sensing subregion and is coupled to the second surface of the flexible substrate at the second sensing subregion. In some examples, the plurality of first sensing lines can be coupled to the first surface of the flexible substrate along the length of the sensing region.

In some examples, a sensing region of the flexible substrate is divided in the longitudinal direction into a plurality of sensing subregions, the plurality of sensing subregions being free of overlap with each other in the longitudinal direction, and wherein only a single respective sensing portion of the plurality of second sensing lines is exposed within each respective sensing subregion. Each sensing portion of the plurality of second sensing lines can be free of overlap in the longitudinal direction with the sensing portions of neighboring second sensing lines of the plurality of second sensing lines.

The sensor system can include one or more control circuits. The control circuits can be configured to enable the sensor system to detect, at 1102, from at least two of the plurality of first sensing lines and at least two of the plurality of second sensing lines, signals describing a user touch input directed to the sensing region of the flexible substrate. The sensor system can, at 1104, determine a longitudinal portion associated with the touch data. In some examples, the sensor system can detect, based on signals from at least two of the plurality of first sensing lines and at least two of the plurality of second sensing lines, that a user has made a swipe gesture along the first surface in the longitudinal direction. In some examples, the sensor system can detect based on the signals, a movement direction of the user touch input, the movement direction having a longitudinal component with respect to the longitudinal direction and a lateral component with respect to the lateral direction.

In some examples, the sensor system can determine a first position of a first touch input at a first time step, the first position including a first longitudinal position and a first lateral position.

In some examples, the sensor system can determine a second position of a first touch input at a second time step, the second position including a second longitudinal position and a second lateral position. In some examples, the sensor system can determine a movement direction based on the first position at the first time step and the second position at the second time step.

In some examples, the longitudinal component is based, at least in part, on one or more signals from the respective second sensing line for at least one of the first sensing subregion or the second sensing subregion of the flexible substrate. The one or more signals from the respective second sensing line can include a first capacitive response associated with the touch input at the first sensing subregion of the flexible substrate and a different, second capacitive response associated with the touch input at the second sensing subregion of the flexible substrate.

In some examples, the sensor system can determine at least one signal difference associated with a respective first sensing line. The sensor system can determine at least one signal difference associated with a respective second sensing line. The sensor system can determine that the touch input is associated with the first sensing subregion of the flexible substrate if the at least one signal difference associated with the respective second sensing line is within a predetermined threshold value from the at least one signal difference associated with the respective first sensing lines. The sensor system can determine that the touch input is associated with the second sensing subregion of the flexible substrate if the at least one signal difference associated with the respective second conductive sensing lines is not within a predetermined threshold value from the at least one signal difference associated with the respective first sensing line.

In some examples, the sensor system can determine a movement pattern from at least the first sensing subregion of the flexible substrate or the second sensing subregion of the flexible substrate at a first time step to a different sensing subregion of the flexible substrate at a second time step.

In some examples, the sensor system can determine, at 1106, based on the movement direction of the user touch input, that the user touch input is associated with one or more gestures. The sensor system can, at 1108, initiate one or more actions based at least in part on determining that the touch input is associated with one or more gestures.

The sensor system can determine whether the movement pattern matches a predetermined movement pattern associated with at least one of a lateral swipe gesture or a longitudinal swipe gesture.

In some examples, the sensor system can identify a first lateral swipe gesture based at least in part on the movement direction indicating that the touch input crosses multiple sensing lines in a first lateral direction. The sensor system can identify a second lateral swipe gesture based at least in part on the movement direction indicating that the touch input crosses multiple sensing lines in a second lateral direction.

In some examples, the sensor system can determine that the movement pattern matches the predetermined movement pattern associated with at least one of the lateral swipe gestures or the longitudinal swipe gesture by identifying a first longitudinal swipe gesture based at least in part on the movement direction indicating that the touch input moves along at least one sensing lines in a first longitudinal direction.

In some examples, the sensor system can identify a second longitudinal swipe gesture based at least in part on the movement direction indicating that the touch input moves along at least one sensing line in a second longitudinal direction. The sensor system can determine whether the touch input is associated with the first surface or the second surface based at least in part on the signals generated in response to the touch input by the plurality of second sensing lines. In some examples, at least one action of the one or more actions includes switching the sensor system from a first user context to a second user context.

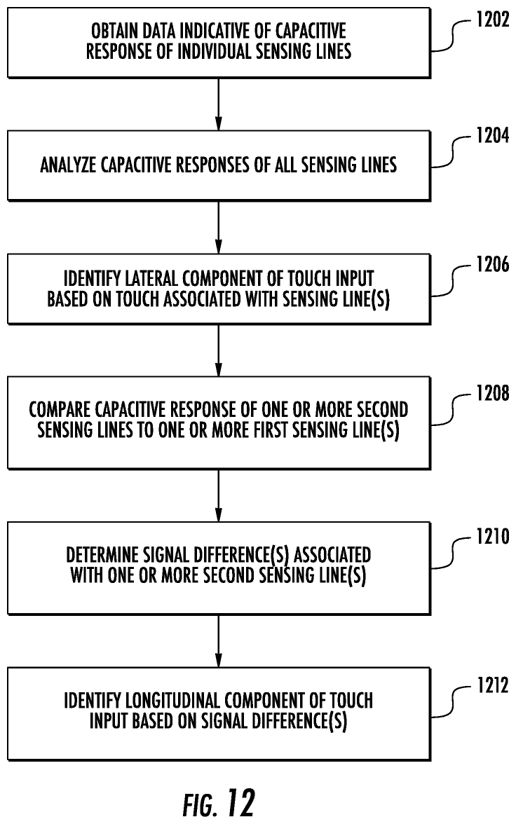

FIG. 12 is a flowchart depicting an example process of determining a touch input location in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-2 and 10.

In some examples, a sensor system (e.g., sensor system 200 in FIG. 3) can obtain data indicative of the capacitive response of individual sensing lines. For example, a user can touch (e.g., with a finger or tool) a sensing region of an interactive object. As a result, the capacitive sensing lines within the sensing region can alter their capacitance which acts as a signal for sensing circuitry within the sensor system.

The sensor system can analyze the capacitive response of all the sensing lines. Based on the capacitive response of all the sensing lines, the sensor system can, at 1206, identify a lateral component of the touch input based on a touch associated with the sensing lines. For example, if the plurality of sensing lines are arranged such that the sensing lines are laterally spaced and run in parallel along the length of the sensing region, each sensing line can be associated with a particular lateral position on the sensing area. Thus, by determining, based on the capacitive response of one or more sensing lines, the sensor system (e.g., sensor system 200 in FIG. 3) can determine the lateral component of the position of the touch input.

The sensor system can, at 1208, compare the capacitive response for one or more second sensing lines with the capacitive response for one or more first sensing lines. Based on the comparison between the one or more second sensing lines and the one or more first sensing lines, the sensor system can, at 1210, determine signal differences associated with the one or more second sensing lines. In some examples, the sensor system can identify, at 1212, a longitudinal component (or location) of the touch input based on the signal differences.

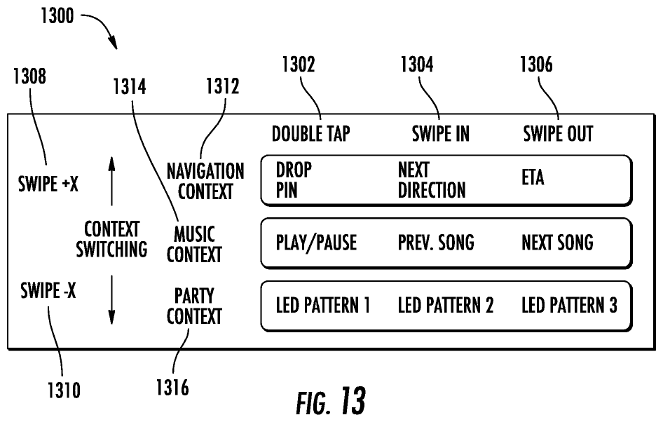

FIG. 13 is a diagram depicting a context switching system for touch inputs in accordance with example embodiments of the present disclosure. In this example, a context switching system 1300 can have a number of associated gestures that it can detect. For example, the gestures can include swiping in the +x direction 1308, swiping in the −x direction 1310, double tapping 1302, swiping in 1304, and swiping out 1306. Each gesture can be associated with a particular action. However, given that the number of actions that may be desired can exceed the number of gestures that can be detected, the context switching system 1300 can enable several different contexts. Each context can associate one or more gestures with different actions based on the current context. Example contexts can include a navigation context 1312, a music context 1314, and a party context 1316.

In some examples, one or more gestures can be associated with switching contexts. In this example, the swipe +x 1308 and the swipe −x 1310 gestures can be associated with switching from one context to another. Once a context is selected, the specific actions associated with particular gestures can be based on the associated context. For example, in the navigation context 1312, the double tap gestures 1302 can be associated with a drop pin action, the swipe in gesture 1304 can be associated with a next direction action, the swipe out gesture 1306 is associated with an eta action.

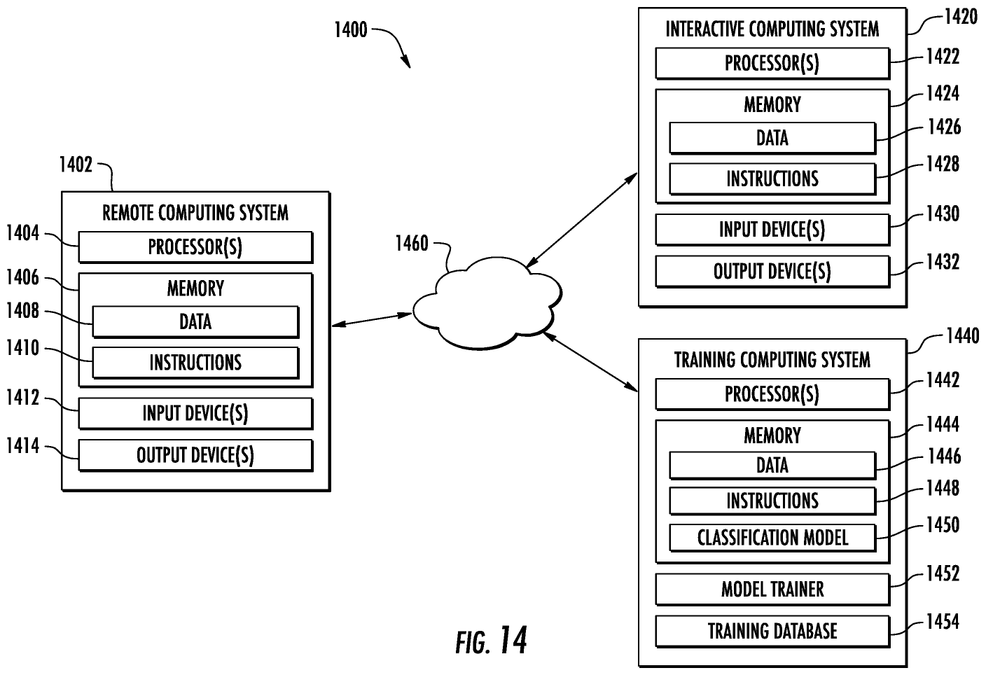

FIG. 14 depicts a block diagram of an example computing environment 1400 that can be used to implement any type of computing device as described herein. The system environment includes a remote computing system 1402, an interactive computing system 1420, and a training computing system 1440 that are communicatively coupled over a network 1460. The interactive computing system 1420 can be used to implement an interactive object in some examples.

The remote computing system 1402 can include any type of computing device, such as, for example, a personal computing device (e.g., laptop or desktop), a mobile computing device (e.g., smartphone or tablet), a gaming console or controller, an embedded computing device, a server computing device, or any other type of computing device.

The remote computing system 1402 includes one or more processors 1404 and a memory 1406. The one or more processors 1404 can be any suitable processing device (e.g., a processor core, a microprocessor, an ASIC, a FPGA, a controller, a microcontroller, etc.) and can be one processor or a plurality of processors that are operatively connected. The memory 1406 can include one or more non-transitory computer-readable storage mediums, such as RAM, ROM, EEPROM, EPROM, flash memory devices, magnetic disks, etc., and combinations thereof. The memory 1406 can store data 1408 and instructions 1410 which are executed by the processor 1404 to cause the remote computing system 1402 to perform operations.

The remote computing system 1402 can also include one or more input devices 1412 that can be configured to receive user input. By way of example, the one or more input devices 1412 can include one or more soft buttons, hard buttons, microphones, scanners, cameras, etc. configured to receive data from a user of the remote computing system 1402. For example, the one or more input devices 1412 can serve to implement a virtual keyboard and/or a virtual number pad. Other example user input devices 1412 include a microphone, a traditional keyboard, or other means by which a user can provide user input.

The remote computing system 1402 can also include one or more output devices 1414 that can be configured to provide data to one or more users. By way of example, the one or more output device(s) 1414 can include a user interface configured to display data to a user of the remote computing system 1402. Other example output device(s) 1414 include one or more visual, tactile, and/or audio devices configured to provide information to a user of the remote computing system 1402.

The interactive computing system 1420 can be used to implement any type of interactive object such as, for example, a wearable computing device. The interactive computing system 1420 includes one or more processors 1422 and a memory 1424. The one or more processors 1422 can be any suitable processing device (e.g., a processor core, a microprocessor, an ASIC, a FPGA, a controller, a microcontroller, etc.) and can be one processor or a plurality of processors that are operatively connected. The memory 1424 can include one or more non-transitory computer-readable storage mediums, such as RAM, ROM, EEPROM, EPROM, flash memory devices, magnetic disks, etc., and combinations thereof. The memory 1424 can store data 1426 and instructions 1428 which are executed by the processor 1422 to cause the interactive computing system 1420 to perform operations.

The interactive computing system 1420 can also include one or more input devices 1430 that can be configured to receive user input. For example, the user input device 1430 can be a touch-sensitive component (e.g., a touch sensor 102) that is sensitive to the touch of a user input object (e.g., a finger or a stylus). As another example, the user input device 1430 can be an inertial component (e.g., inertial measurement unit 158) that is sensitive to the movement of a user. Other example user input components include a microphone, a traditional keyboard, or other means by which a user can provide user input. The interactive computing system 1420 can also include one or more output devices 1432 configured to provide data to a user. For example, the one or more output devices 1432 can include one or more visual, tactile, and/or audio devices configured to provide the information to a user of the interactive computing system 1420.

The training computing system 1440 includes one or more processors 1442 and a memory 1444. The one or more processors 1442 can be any suitable processing device (e.g., a processor core, a microprocessor, an ASIC, a FPGA, a controller, a microcontroller, etc.) and can be one processor or a plurality of processors that are operatively connected. The memory 1444 can include one or more non-transitory computer-readable storage mediums, such as RAM, ROM, EEPROM, EPROM, flash memory devices, magnetic disks, etc., and combinations thereof. The memory 1444 can store data 1446 and instructions 1448 which are executed by the processor 1442 to cause the training computing system 1440 to perform operations. In some implementations, the training computing system 1440 includes or is otherwise implemented by one or more server computing devices.

The training computing system 1440 can include a model trainer 1452 that trains a machine-learned classification model 1450 using various training or learning techniques, such as, for example, backwards propagation of errors. In other examples as described herein, training computing system 1440 can train machine-learned classification model 1450 using training data 1454. For example, the training data 1454 can include labeled sensor data generated by interactive computing system 1420. The training computing system 1440 can receive the training data 1454 from the interactive computing system 1420, via network 1460, and store the training data 1454 at training computing system 1440. The machine-learned classification model 1450 can be stored at training computing system 1440 for training and then deployed to remote computing system 1402 and/or the interactive computing system 1420. In some implementations, performing backwards propagation of errors can include performing truncated backpropagation through time. The model trainer 1452 can perform a number of generalization techniques (e.g., weight decays, dropouts, etc.) to improve the generalization capability of the classification model 1450.

In particular, the training data 1454 can include a plurality of instances of sensor data, where each instance of sensor data has been labeled with ground truth inferences such as one or more predefined movement recognitions. For example, the label(s) for each instance of sensor data can describe the position and/or movement (e.g., velocity or acceleration) of an object movement. In some implementations, the labels can be manually applied to the training data by humans. In some implementations, the machine-learned classification model 1450 can be trained using a loss function that measures a difference between a predicted inference and a ground-truth inference.

The model trainer 1452 includes computer logic utilized to provide desired functionality. The model trainer 1452 can be implemented in hardware, firmware, and/or software controlling a general purpose processor. For example, in some implementations, the model trainer 1452 includes program files stored on a storage device, loaded into a memory and executed by one or more processors. In other implementations, the model trainer 1452 includes one or more sets of computer-executable instructions that are stored in a tangible computer-readable storage medium such as RAM hard disk or optical or magnetic media.

In some examples, a training database 1456 can be stored in memory on an interactive object, removable electronics module, user device, and/or a remote computing device. For example, in some embodiments, a training database 1456 can be stored on one or more remote computing devices such as one or more remote servers. The machine-learned classification model 1450 can be trained based on the training data in the training database 1456. For example, the machine-learned classification model 1450 can be learned using various training or learning techniques, such as, for example, backwards propagation of errors based on the training data from training database 1456.

In this manner, the machine-learned classification model 1450 can be trained to determine at least one of a plurality of predefined movement(s) associated with the interactive object based on movement data.

The machine-learned classification model 1450 can be trained, via one or more machine learning techniques using training data. For example, the training data can include movement data previously collected by one or more interactive objects. By way of example, one or more interactive objects can generate sensor data based on one or more movements associated with the one or more interactive objects. The previously generated sensor data can be labeled to identify at least one predefined movement associated with the touch and/or the inertial input corresponding to the sensor data. The resulting training data can be collected and stored in a training database 1456.

The network 1460 can be any type of communications network, such as a local area network (e.g., intranet), wide area network (e.g., Internet), or some combination thereof and can include any number of wired or wireless links. In general, communication over the network 1460 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 16 illustrates one example computing system that can be used to implement the present disclosure. Other computing systems can be used as well. For example, in some implementations, the remote computing system 1402 can include the model trainer 1452 and the training data 1454. In such implementations, the classification model 1450 can be trained and used locally at the remote computing system 1402. In some of such implementations, the remote computing system 1402 can implement the model trainer 1452 to personalize the classification model 1450 based on user-specific movements.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A sensor system, comprising:
a flexible substrate having a first surface and an opposite, second surface, the flexible substrate defining a longitudinal direction and a lateral direction;
a plurality of first sensing lines extending in the longitudinal direction of the flexible substrate and being substantially parallel and spaced apart in the lateral direction, wherein each of the plurality of first sensing lines is coupled to the first surface of the flexible substrate within a sensing region having a length in the longitudinal direction;
a plurality of second sensing lines extending in the longitudinal direction of the flexible substrate and substantially parallel with the plurality of first sensing lines, wherein at least a first portion of each of the plurality of second sensing lines is exposed on the first surface of the flexible substrate within the sensing region and at least a second portion of each of the plurality of second sensing lines is exposed on the second surface of the flexible substrate within the sensing region; and
one or more control circuits configured to:
detect, based on signals from at least two of the plurality of first sensing lines and at least two of the plurality of second sensing lines, that a user has made a swipe gesture along the first surface in the longitudinal direction.

2. The sensor system of claim 1, wherein the signals from at least two of the plurality of first sensing lines and at least two of the plurality of second sensing lines describe a user touch input directed to the sensing region of the flexible substrate.

3. The sensor system of claim 2, wherein the one or more control circuits are configured to detect, based on signals from at least two of the plurality of first sensing lines and at least two of the plurality of second sensing lines, that the user has made the swipe gesture along the first surface in the longitudinal direction by:
determining, based on the signals, a movement direction of the user touch input, the movement direction having a longitudinal component with respect to the longitudinal direction and a lateral component with respect to the lateral direction.

4. The sensor system of claim 3, wherein the one or more control circuits are configured to determine, based on the signals, the movement direction by:
determining whether the movement direction matches a predetermined movement pattern associated with at least one of a lateral swipe gesture or a longitudinal swipe gesture.

5. The sensor system of claim 4, wherein the one or more control circuits are configured to determine that the movement direction matches the predetermined movement pattern associated with at least one of the lateral swipe gesture or the longitudinal swipe gesture by:
identifying a first lateral swipe gesture based at least in part on the movement direction indicating that the user touch input crosses multiple sensing lines in a first lateral direction; and
identifying a second lateral swipe gesture based at least in part on the movement direction indicating that the user touch input crosses multiple sensing lines in a second lateral direction.

6. The sensor system of claim 5, wherein the one or more control circuits are configured to
determine that the movement direction matches the predetermined movement pattern associated with at least one of the lateral swipe gesture or the longitudinal swipe gesture by:
identifying a first longitudinal swipe gesture based at least in part on the movement direction indicating that the user touch input moves along at least one sensing lines in a first longitudinal direction; and
identifying a second longitudinal swipe gesture based at least in part on the movement direction indicating that the user touch input moves along at least one sensing line in a second longitudinal direction.

7. The sensor system of claim 3, wherein the flexible substrate includes a first sensing subregion and a second sensing subregion.

8. The sensor system of claim 7, wherein a respective second sensing line is coupled to the first surface of the flexible substrate at the first sensing subregion of the flexible substrate and coupled to the second surface of the flexible substrate at the second sensing subregion of the flexible substrate.

9. The sensor system of claim 8, wherein the longitudinal component is based, at least in part, on one or more signals from the respective second sensing line for at least one of the first sensing subregion or the second sensing subregion of the flexible substrate.

10. The sensor system of claim 9, wherein the one or more signals from the respective second sensing line includes a first capacitive response associated with the user touch input at the first sensing subregion of the flexible substrate and a different, second capacitive response associated with the user touch input at the second sensing subregion of the flexible substrate.

11. The sensor system of claim 10, wherein the one or more control circuits are configured to determine whether the user touch input is associated with at least one of the first sensing subregion or the second sensing subregion by:
determining at least one signal difference associated with one or more of the plurality of first sensing lines;
determining at least one signal difference associated with one or more of the plurality of second sensing lines;
determining that the user touch input is associated with the first sensing subregion of the flexible substrate if the at least one signal difference associated with the one or more of the plurality of second sensing lines is within a predetermined threshold value from the at least one signal difference associated with the one or more of the plurality of first sensing lines; and
determining that the user touch input is associated with the second sensing subregion of the flexible substrate if the at least one signal difference associated with the one or more of the plurality of second sensing lines is not within a predetermined threshold value from the at least one signal difference associated with the one or more of the plurality of first sensing lines.

12. The sensor system of claim 7, wherein the one or more control circuits are configured to determine, based on the signals, the movement direction of the user touch input by:
detecting movement from a first position at a first time step to a second position at a second time step, the first position including a first longitudinal position and a first lateral position, the second position including a second longitudinal position and a second lateral position; and
determining whether a longitudinal gesture or a lateral gesture has been performed based on the movement from the first position to the second position.

13. The sensor system of claim 7, wherein:
the flexible substrate includes a third sensing subregion;
a respective first sensing line is coupled to the first surface of the flexible substrate at the first sensing subregion, the second sensing subregion, and the third sensing subregion of the flexible substrate; and
a respective second sensing line is coupled to the second surface of the flexible substrate at the first sensing subregion and the third sensing subregion of the flexible substrate and is coupled to the first surface at the second sensing subregion of the flexible substrate.

14. The sensor system of claim 7, wherein:
the flexible substrate includes a third sensing subregion; and
a respective first sensing line is coupled to the first surface at the first sensing subregion and the second sensing subregion and is coupled to the second surface at the third sensing subregion of the flexible substrate; and
a respective second sensing line is coupled to the first surface of the flexible substrate at the first sensing subregion and the third sensing subregion and is coupled to the second surface of the flexible substrate at the second sensing subregion.

15. The sensor system of claim 3, wherein
the plurality of first sensing lines are coupled to the first surface of the flexible substrate along the length of the sensing region; and
the one or more control circuits are configured to determine whether the user touch input is associated with the first surface or the second surface based at least in part on the signals generated in response to the user touch input by the plurality of second sensing lines.

16. The sensor system of claim 3, wherein the one or more control circuits are configured to:
determine, based on the movement direction of the user touch input, that the user touch input is associated with one or more gestures; and
initiate one or more actions based at least in part on determining that the user touch input is associated with one or more gestures.

17. The sensor system of claim 16, wherein at least one action of the one or more actions includes switching the sensor system from a first user context to a second user context.

18. The sensor system of claim 1, wherein the sensor system is integrated with a wearable device.

19. The sensor system of claim 1, the sensor system is a capacitive touch sensor.

20. The sensor system of claim 1, wherein the sensing region of the flexible substrate is divided in the longitudinal direction into a plurality of sensing subregions, the plurality of sensing subregions being free of overlap with each other in the longitudinal direction, and wherein only a single respective sensing portion of the plurality of second sensing lines is exposed within each respective sensing subregion.

21. The sensor system of claim 20, wherein each sensing portion of the plurality of second sensing lines is free of overlap in the longitudinal direction with sensing portions of neighboring second sensing lines of the plurality of second sensing lines.

22. The sensor system of claim 1, wherein the plurality of first sensing lines are approximately equally spaced apart in the lateral direction.

23. The sensor system of claim 1, wherein each of the plurality of second sensing lines is arranged between a respective pair of first sensing lines such that the first sensing lines alternate with the second sensing lines in the lateral direction.

24. A computer-implemented method of determining a user gesture, comprising:
detecting, from at least two of a plurality of first sensing lines and at least two of a plurality of second sensing lines, signals describing a user touch input directed to a sensing region of a flexible substrate, the flexible substrate having a first surface and an opposite, second surface, the flexible substrate defining a longitudinal direction and a lateral direction, the plurality of first sensing lines extending in the longitudinal direction and being substantially parallel and spaced apart in the lateral direction, wherein each of the plurality of first sensing lines is coupled to the first surface of the flexible substrate within a sensing region having a length in the longitudinal direction, the plurality of second sensing lines extend in the longitudinal direction of the flexible substrate and substantially parallel with the plurality of first sensing lines, wherein at least a portion of each of the plurality of second sensing lines is exposed on the first surface of the flexible substrate within the sensing region and at least a second portion of each of the plurality of second sensing lines is exposed on the second surface of the flexible substrate within the sensing region; and
determining, based on the signals, that a user has made a swipe gesture along the first surface in the longitudinal direction.

25. An interactive object, comprising:
a touch sensor comprising a plurality of conductive sensing lines integrated with a flexible substrate, the plurality of conductive sensing lines comprising a first conductive sensing line coupled to a first surface of the flexible substrate at a first sensing subregion and a second sensing subregion of the flexible substrate and a second conductive sensing line coupled to the first surface of the flexible substrate at the first sensing subregion and a second surface of the flexible substrate at the second sensing subregion; and
one or more control circuits configured to:
obtain touch data associated with a touch input to the touch sensor, the touch data indicative of a respective response to the touch input by the plurality of conductive sensing lines; and
determine whether the touch input is associated with the first sensing subregion or the second sensing subregion of the flexible substrate based at least in part on the respective response to the touch input by the plurality of conductive sensing lines.
